(19) United States
(12) Patent Application Publication
(10) Pub. No.: US 2018/0172461 A1
(43) Pub. Date: Jun. 21, 2018

(54) APPARATUS, SERVER APPARATUS FOR ROUTE SEARCH, AND NON-TRANSITORY COMPUTER-READABLE STORAGE MEDIUM FOR ROUTE SEARCH

(71) Applicant: FUJITSU LIMITED, Kawasaki-shi (JP)

(72) Inventors: Asako KATAYAMA, Kawasaki (JP); Kyoko Ohashi, Fuchu (JP); Naoki HASEGAWA, Kawasaki (JP)

(73) Assignee: FUJITSU LIMITED, Kawasaki-shi (JP)

(21) Appl. No.: 15/830,556

(22) Filed: Dec. 4, 2017

(30) Foreign Application Priority Data
Dec. 19, 2016 (JP) 2016-245856

(51) Int. Cl. G01C 21/34; G01C 21/36

(52) U.S. Cl. CPC G01C 21/3423; G01C 21/3415; G01C 21/3676; G01C 21/3617; G01C 21/3484

(57) ABSTRACT

An apparatus executes a process A-1 for measuring movement of a user, executes a process A-2 for determining a walking condition indicating a walking status of the user from the movement measured by the process A-1, executes a process A-3 for setting the information on the walking condition of the user to a search condition including a departure location and a destination, executes a process A-4 for transmitting a search request including the search condition, to a route search server searching a route candidate including the departure location and the destination indicated by the search condition, and searching the route candidate including a transfer section that satisfies the walking condition if necessary, executes a process A-5 for receiving a search result including the route candidate that satisfies the search condition, from the route search server, and executes a process A-6 for displaying the route candidate of the search result.

### CROSS-REFERENCE TO RELATED APPLICATION

This application is based upon and claims the benefit of priority of the prior Japanese Patent Application No. 2016-245856, filed on Dec. 19, 2016, the entire contents of which are incorporated herein by reference.

### FIELD

The embodiments discussed herein are related to an apparatus, a server apparatus, and a non-transitory computer-readable storage medium for storing a program for route search.

### BACKGROUND

Conventionally, known are navigation apparatuses and navigation systems that guide a user by searching map data, road data, and a route from a desired departure location to a destination. As such navigation apparatuses, car navigation apparatuses and others that each are mounted to an automobile and guide a vehicle driver to a route have become commercially practical. Moreover, as such navigation systems, communication type navigation systems and others that each send a search request to a route search server using a mobile telephone as a navigation terminal, receive a result thereof, and conduct a route guidance have become commercially practical.

For example, the communication type navigation system is a system that uses a mobile terminal, such as a mobile telephone, as a navigation terminal, and is also used as a pedestrian navigation system. Further, the route search server is provided with a database including nodes that are positions of nodal points and turning points of roads (routes) of map data and links that are routes linking the respective nodes, and including cost information (distance or movement time) on all of the links. Further, a route guidance server refers to the database to successively search links from a node of a departure location reaching a node at a destination, and sets a guidance route that follows along the nodes and the links with the minimum cost information of the links, thereby making it possible to guide the shortest route to the navigation terminal. As methods of such a route search, a method called the label-correcting method or the Dijkstra method is used.

The pedestrian navigation system to which a route guidance function including transport facilities may be preferable. There exist navigation systems having the function, in addition to the search and the guidance for on-foot routes, of accumulating route lines and operation time data of the transport facilities in a route search server, and guiding a route (boarding candidate train) from a desired departure location station (also referred to as boarding station) to a desired destination station (also referred to as getting-off station) in addition to the search and the guidance for on-foot routes.

Such a route search system searching a route that uses the transport facilities may be provided with, as route search data, operation time database in which operation time data of each of the transport facilities is made to a database. Moreover, this route search system may be provided with, similar to road network data in an in-vehicle use navigation system or a pedestrian navigation system, in addition to data in which nodes that are respective stations in the traffic route lines and a bidirectional link between the stations form a network, and data in which a traffic network with the operation time and the movement time of each link being added as link cost data for every traffic unit operated on each traffic route line is made to a database. In addition, a system to which fare data is added that also guides the fare of the searched guidance route guided may exist.

Further, the system is configured to refer to, based on a search request designated by a user and including the departure date/time, the departure location, the destination, and the arrival time, the database thereof, successively follow a route of available traffic facilities (respective trains and route buses) that connects the departure location and the destination, in addition to transits (transfer), and to present one or a plurality of candidates of a guidance route that matches the search condition (the departure location station, the destination station, the route line, and the traffic facilities such as a train). As a search condition, the conditions such as the movement time, the number of transits, and the fare may be generally designated.

From such a technical background, various technologies that use such transport facilities and search a route from a departure location to a destination, in addition to the transits have been proposed.

Firstly, known is a technology of storing the operation time of transport facilities and the transfer time used to transfer between the transport facilities, and searching, based on the operation time and the transfer time, a traffic route from the departure location to the destination.

Secondary, known is a technology of measuring the walking time of a user in transfer places by a mobile terminal apparatus to which an acceleration sensor is mounted, accumulating data related to the transfer time in the respective transfer places by subjecting the walking time for every transfer place collected from the mobile terminal apparatus to a statistical process, and thereby performing a route search based on the transfer time in accordance with the actual situation.

Thirdly, known is a technology of providing a suitable traffic route to a user in consideration of the transfer time in accordance with individual characteristics, such as a case where the user has a walking speed slower than that of ordinary people and uses the more transfer time. With this technology, it is considered that the individual characteristics are set in advance in an information delivery server, and a suitable traffic route may be provided to the user by the estimation of the transfer time in accordance with the individual characteristics upon reception of a search request from a terminal.

Fourthly, there is a technology of considering the walking speed of individuals in the calculation of the desired time to the destination. With this related art, it is considered that the traveling speed of a mobile information terminal apparatus is detected, and the desired time to a station is calculated based on the detected traveling speed, so that the desired time to the station from a current position in association with the traveling speed of a person carrying the mobile information terminal apparatus is calculated and displayed, this allows the person carrying the apparatus to substantially accurately grasp the possible time to arrive at the station.

Fifthly, known is a technology of causing a user to select a movement aspect in transferring, out of three stages of “slow”, “standard”, and “fast” when making a search request, and reflecting the selection on a result of the route search.

Examples of the related art include Japanese Laid-open Patent Publication Nos. 10-76950, 2006-193030, 2007-183880, 2003-337045, and 2009-103657.

### SUMMARY

According to an aspect of the invention, an apparatus for a route search includes: a memory; and a processor coupled to the memory and configured to execute a process A-1 that includes measuring information related to movement of a user, execute a process A-2 that includes determining a walking condition indicating a walking status of the user, based on the information related to the movement of the user measured by the process A-1, execute a process A-3 that includes setting the information related to the walking condition of the user obtained by the process A-2 to a search condition including a departure location and a destination, execute a process A-4 that includes transmitting a search request including the search condition, to a route search server that searches a route candidate including the departure location and the destination indicated by the search condition, and searches, when the route candidate includes a transfer section, the route candidate including the transfer section that satisfies the walking condition, execute a process A-5 that includes receiving a search result including the route candidate that satisfies the search condition, from the route search server, and execute a process A-6 that includes displaying the route candidate included in the search result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a system configuration diagram illustrating the configuration of a route search system according to a first embodiment;

FIG. 2 is a block diagram illustrating the detailed configuration of the route search system according to the first embodiment;

FIG. 3 is a diagram illustrating one example of a search condition input screen that is displayed on a display of a terminal apparatus;

FIG. 4 is a diagram illustrating one example of a search result;

FIG. 5 is a diagram illustrating one example of a search result display screen that is displayed on the display of the terminal apparatus;

FIG. 6 is a diagram schematically illustrating a content example of a route search network database;

FIG. 7 is a route line map schematically illustrating relations among three route lines stored in the route search network database;

FIG. 8 is a diagram illustrating one example of a station timetable database that stores therein the departure time of a train in the direction of a station C8 at a station X of a route line C;

FIG. 9 is a flowchart illustrating one example of a flow of the process in the terminal apparatus according to the first embodiment;

FIG. 10 is a diagram illustrating a content example of a search request that is transmitted from the terminal apparatus to a route search server;

FIG. 11 is a flowchart illustrating one example of a flow of the process of the route search server according to the first embodiment;

FIG. 12 is a block diagram illustrating the detailed configuration of a route search system according to a second embodiment;

FIG. 13 is a flowchart illustrating one example of a flow of the process in a terminal apparatus according to the second embodiment;

FIG. 14 is a diagram illustrating one example of a search result display screen on which a search result corrected based on the walking speed of a user is displayed;

FIG. 15 is a block diagram illustrating the detailed configuration of a route search system according to a third embodiment;

FIG. 16 is a flowchart illustrating one example of a flow of the process in a terminal apparatus according to the third embodiment;

FIG. 17 is a diagram illustrating a content example of a re-search request;

FIG. 18 is a diagram illustrating a content example of a re-search result;

FIG. 19 is a diagram illustrating a content example of a search result after the correction;

FIG. 20 is a diagram illustrating one example of a search result display screen that is displayed based on the search result after the correction; and

FIG. 21 is a diagram illustrating one example of the hardware configuration of the terminal apparatus and the route search server in the route search system.

### DESCRIPTION OF EMBODIMENTS

The inventors of the embodiments discussed herein have made diligent studies on implementing the human centric society that creates new values with the technology centering on people in the field of route search services. As a result, the inventors consequently come to note that the abovementioned related arts put a burden of an operation on a user, and thus the route search service is not sufficiently utilized.

Firstly, although a route is retrieved by considering the transfer time used for the transfer between transport facilities in the abovementioned related art, the transfer time for every transfer place is fixed, and the current status of a user is not considered. Therefore, an optimal route search in accordance with the current status of the user is not made.

Secondary, although the transfer time based on the walking time having been collected in the past is estimated in the abovementioned related art, the status where the walking time having been collected in the past is different from the current status of the user. Therefore, an optimal route search in accordance with the current status of the user is not made.

Thirdly, individual characteristics have to be set in advance in the abovementioned related art, so that a burden for the setting operation puts on the user, and an optimal route search in accordance with the current status of the user is not made because the setting may be different from the current status of the user.

Fourthly, although the traveling speed of the mobile information terminal is detected when a search request is made in the abovementioned related art, the desired time is simply estimated from the current position to the closest station based on the detected traveling speed, and the current status of the user is not estimated when the search request is made. Therefore, also with the abovementioned related art, it is not considered that an optimal route search in accordance with the current status of the user may be made.

Fifthly, a burden for the setting operation puts on the user, and an optimal route search in accordance with the current status of the user is not made because the setting may be different from the current status of the user.

In other words, the technical problem that an optimal route search may not be made remains in the abovementioned related arts.

Therefore, the inventors of the embodiments discussed herein have found that the development of a technology of grasping an action of a user (also referred to as the current status of a user) by a sensor carried by the user, and setting a search condition of a route search using the grasped result, by an information processing apparatus, may implement an optimal route search in accordance with the current status of the user, and completed the embodiments discussed herein.

Hereinafter, forms (hereinafter, also referred to as embodiments or examples) for carrying out the disclosure are described with reference to the drawings. The configuration of embodiments indicated below only indicates one example for embodying the technical concept of the disclosure, is not intended to limit the disclosure to the configuration of the embodiments, and is equally applicable to other embodiments included in the scope of the claims.

### First Embodiment

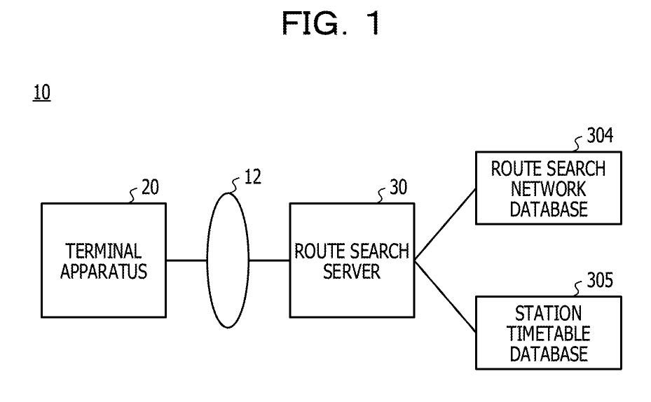

FIG. 1 is a system configuration diagram illustrating the configuration of a route search system 10 according to the first embodiment. The route search system 10 is configured to include a terminal apparatus 20 and a route search server 30, which are coupled to each other via a network 12, as illustrated in FIG. 1. It is assumed that the communication between the terminal apparatus 20 and the route search server 30 via the network 12 is conducted via wireless communication with a wireless access point (also referred to as a wireless base station), which is not illustrated.

The route search server 30 illustrated in FIG. 1 is provided with a route search network database 304 and a station timetable database 305, and in response to a search request from the terminal apparatus 20, searches a route by referring to the route search network database 304 and the station timetable database 305. Further, the route search server 30 has a general navigation function of transmitting a guidance route (recommended route) obtained by a result of the route search, to the terminal apparatus 20.

When the terminal apparatus 20 requests a route search of the route search server 30, and receives a service of route guidance, the terminal apparatus 20 sets a search condition such as a desired departure location or destination, and transmits the search request to the route search server 30. In that case, the terminal apparatus 20 measures information related to movement of a user, and determines, based on a measurement result thereof, a walking condition (hereinafter, also referred to as the walking condition in accordance with the status of the user, or the status of the user) indicating the current walking status of the user, and sets information related to the walking condition of the user obtained through the determination to a search condition, and transmits the search condition to the route search server 30.

When the route search server 30 receives a search request in which such a search condition in accordance with the walking status of the user is set, from the terminal apparatus 20, the route search server 30 refers to the route search network database 304 and the station timetable database 305, selects a transfer cost in accordance with the status of the user, and adds the selected transfer cost to a desired time cost that is included in the route search network database 304, as is described later, thereby searching a candidate route.

Conducting such a route search makes it possible to automatically set the walking condition in accordance with the current walking status of the user of the terminal apparatus 20 to the search condition, which is transmitted to the route search server 30, and obtain a candidate route allowing the user to arrive at a destination with a transfer that satisfies the automatically set walking condition in accordance with the walking status of the user. This enables the user of the terminal apparatus 20 to obtain a desired route that further matches the own request.

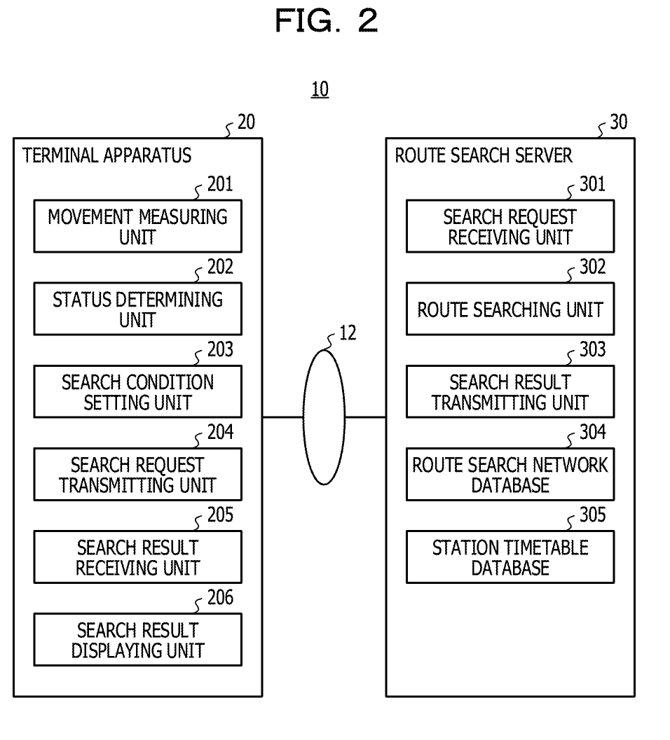

Hereinafter, the route search system 10 according to the first embodiment is described based on a specific example. FIG. 2 is a block diagram illustrating the detailed configuration of the route search system 10 according to the first embodiment.

The terminal apparatus 20 illustrated in FIG. 2 is a terminal that may receive route search service, and is provided with a movement measuring unit 201, a status determining unit 202, a search condition setting unit 203, a search request transmitting unit 204, a search result receiving unit 205, and a search result displaying unit 206. Each function unit of the terminal apparatus 20 illustrated in FIG. 2 is implemented in such a manner that a processor included in the terminal apparatus 20 executes a program stored in a memory, for example. In other words, the processor of the terminal apparatus 20 executes the program stored in the memory accordingly to be converted into a circuit that implements each function unit of the terminal apparatus 20 illustrated in FIG. 2. The terminal apparatus 20 is one example of an information processing apparatus.

The movement measuring unit 201 is configured to measure information related to movement of a user. The information related to the movement of the user may be information indicating the number of steps that the user has walked within a predetermined period of time, or may be information indicating the walking speed of the user that is calculated from a difference of two or more position information acquired based on GPS signals, for example. Hereinafter, as a specific example of the information related to the movement of the user, an example of information related to the walking of the user is described. The inventors of the embodiments discussed herein has reached the finding that as an example of measuring information related to the movement of the user (information related to the walking of the user), measuring the number of steps of the user using an acceleration sensor is especially useful in the viewpoint of saving the battery of the terminal apparatus 20. Therefore, as an example of measuring information related to the movement of the user, an example of measuring the number of steps of the user using an acceleration sensor is described hereinafter. For example, the number of steps that the user has walked may be measured based on detection signals from the acceleration sensor that is accessible from the terminal apparatus 20. Noted that the disclosure is not limited to the example in which the acceleration sensor is used.

In the present embodiment, the movement measuring unit 201 sets a measurement target to the number of steps that the user has walked (hereinafter, also referred to as the measurement time number of steps, the first number of steps) during a given time section (also referred to as measurement target time, for example, one minute) going back from the present time. The starting point of this measurement target time moves for every measuring unit time (for example, 10 seconds) shorter than the measurement target time, along with the progress in the current time. The movement measuring unit 201 may measure the number of steps that the user has walked within the measurement target time by recording the number of steps (hereinafter, also referred to as the unit time number of steps, the second number of steps) measured for every measuring unit time, and summing up the respective numbers of steps in a plurality of measuring unit times included in the measurement target time from the current time as the starting point. Further, in the unit time number of steps that is referred when the measurement time number of steps is acquired, a measuring unit time in which the unit time number of steps is less than a predetermined value (for example, less than 1) is excluded from a calculation target for the measurement time number of steps, and the number of steps in a past measuring unit time equivalent to the excluded measuring unit time may be included in the calculation target. This allows, for example, the measuring unit time during which the user temporarily stops, such as a case where the user stops to operate the terminal apparatus 20, to be excluded, and allows the more accurate measurement. The acceleration sensor may be mounted to the terminal apparatus 20, or may be mounted independent of the terminal apparatus 20. For example, the movement measuring unit 201 of the terminal apparatus 20 may acquire information on the number of steps that is measured, based on a detection signal from an acceleration sensor mounted to electronic equipment that is installed to the body of the user, by a processor of the electronic equipment for every measuring unit time, via a short distance wireless communication (for example, Bluetooth (registered trademark)).

The status determining unit 202 is configured to determine a walking condition indicating the walking status of the user, based on the number of steps measured by the movement measuring unit 201 within a predetermined period of time. For example, the status determining unit 202 acquires the number of steps that the user has walked (the measurement time number of steps) within the measurement target time from the movement measuring unit 201, and compares the walking speed that is acquired from the acquired measurement time number of steps using the known algorithm with one or more thresholds, thereby determining a walking condition indicating the walking status of the user. For example, when the walking status of the user is classified into three stages of “high-speed walking”, “standard walking”, and “low-speed walking”, set are a first threshold that defines a boundary between the high-speed walking and the standard walking, and a second threshold that defines a boundary between the standard walking and the low-speed walking, and the status determining unit 202 determines the magnitude relation between the measurement time number of steps and each of the first threshold and the second threshold, and accordingly may classify the walking status of the user into any of the walking states indicated in the three stages. For example, the status determining unit 202 may determine the walking status of a current user as “standard walking” when the measurement time number of steps falls within a range that is defined by the first threshold and the second threshold. Alternatively, the status determining unit 202 may determine the current walking status of the user as the “low-speed walking” when the measurement time number of steps is less than the second threshold. Similarly, the status determining unit 202 may determine the current walking status of the user as the “high-speed walking” when the measurement time number of steps exceeds the first threshold. For example, the first threshold may be 90 m/minute, and the second threshold may be 75 m/minute. Note that, when the movement measuring unit 201 measures, as information related to the movement of the user, information indicating the walking speed of the user that is calculated from a difference of two or more position information acquired based on GPS signals, the status determining unit 202 may determine the walking status of the user by comparing the walking speed of the user indicated in the information related to the walking of the user with one or more thresholds.

The search condition setting unit 203 is configured to set the information related to the walking condition of the user obtained by the determination to a search condition including a departure location and a destination. For example, the search condition setting unit 203 receives an input of a search condition including a departure location and a destination in such a manner that a value is inputted into an entry field on an input screen displayed on the display that is mounted to the terminal apparatus 20, through an input operation by the user. The search condition may include the departure time.

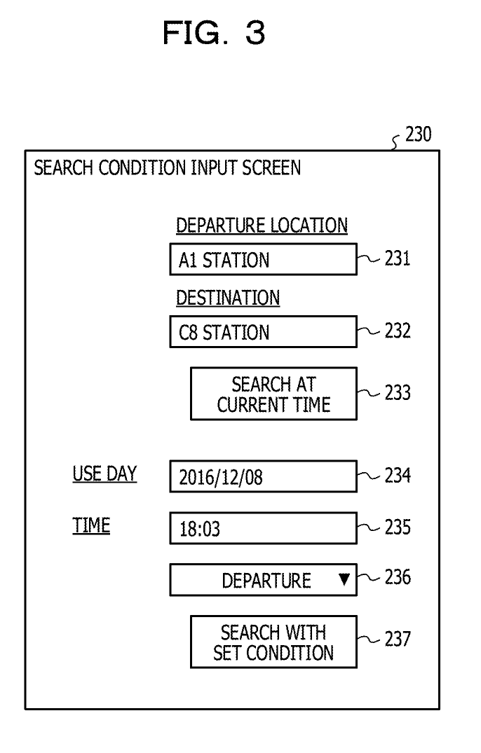

FIG. 3 is a diagram illustrating one example of a search condition input screen 230 that is displayed on the display of the terminal apparatus 20. The search condition input screen 230 illustrated in FIG. 3 is provided with a departure location entry field 231, a destination entry field 232, a search start button 233 at current time (hereinafter, also referred to as first search button), a use date entry field 234, a time entry field 235, a time type entry field 236, and a search start button 237 with set condition (hereinafter, also referred to as second search button). The departure location and the destination may be set through text inputs of a station name or the like into the departure location entry field 231 and the destination entry field 232. The use date and the time may be similarly set through text inputs into the use date entry field 234 and the time entry field 235. In the time type entry field 236, as the type of time set to the search condition, “departure time”, “arrival time”, “last train”, “first train”, and others may be selected. These settings are similar to the conventional ones, and explanations thereof are thus omitted. Moreover, the input screen illustrated in FIG. 3 is merely one example, and other setting items may be provided.

The search condition setting unit 203 receives an input of a search condition that is set based on values inputted into various kinds of entry fields, for example, with a press on the first search button 233 or the second search button 237 by the user, and sets the information related to the walking condition of the user that is acquired from the status determining unit 202, to the search condition. This allows the search condition to be automatically set using the walking condition that is in accordance with the status of the user and determined based on the measurement value of the number of steps that the user has walked.

The search request transmitting unit 204 is configured to receive the search condition that is set using the walking condition in accordance with the status of the user, and transmit a search request including the search condition to the route search server 30 via the network 12. This allows the route search server 30 that searches a route candidate including a departure location and a destination indicated by the search condition to search a route candidate including a transfer section such that the transfer section satisfies the walking condition in accordance with the status of the user.

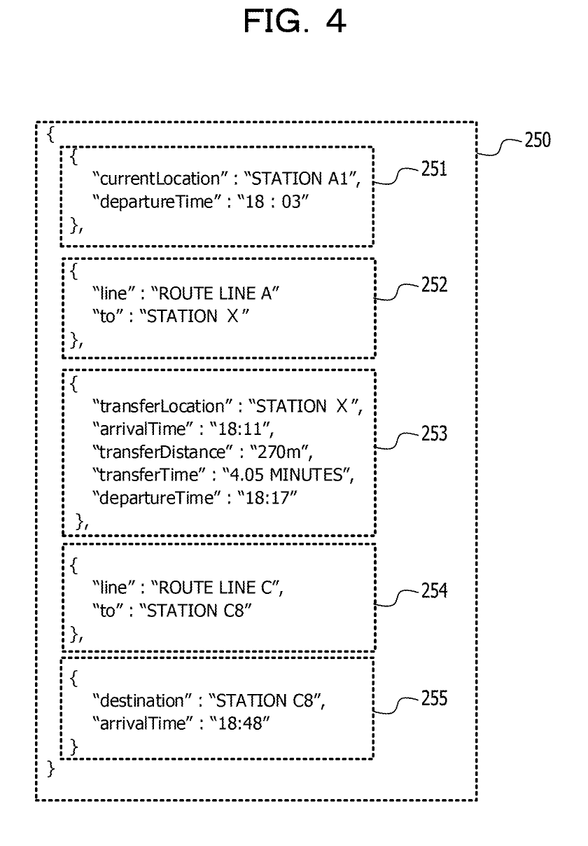

The search result receiving unit 205 is configured to receive a search result including a route candidate that satisfies the search condition from the route search server 30. FIG. 4 is a diagram illustrating one example of a search result. A search result 250 illustrated in FIG. 4 is written in Java Script Object Notation (JSON) format, and includes one route candidate configured by a departure location object 251, a boarding object 252, a transfer object 253, a boarding object 254, and a destination object 255. In other words, in the example illustrated in FIG. 4, the one route candidate included in the search result includes one departure location object 251, the two boarding objects 252 and 254, one transfer object 253, and one destination object 255. The number of objects of various kinds may naturally increase or decrease depending on the content of the candidate route. The departure location object 251 includes an attribute “currentLocation” indicating the departure location and an attribute “departureTime” indicating the departure time. In the example illustrated in FIG. 4, “station A1” is set to the attribute “currentLocation” and “18:03” is set to the attribute “departureTime”. The first boarding object 252 includes an attribute “line” indicating the boarding route line and an attribute “to” indicating the getting-off station in the boarding route line. In the example illustrated in FIG. 4, “route line A” is set to the attribute “line” and “station X” is set to the attribute “to”. The transfer object 253 includes an attribute “transferLocation” indicating the transfer destination station name, an attribute “arrivalTime” indicating the arrival expectation time (hereinafter, also referred to as arrival time) to the transfer destination origin station, an attribute “transferDistance” indicating the estimation of a distance of the movement route from the transfer origin to the transfer destination, an attribute “transferTime” indicating the desired time of the movement from the transfer origin to the transfer destination, and an attribute “departureTime” indicating the departure expectation time (hereinafter, also referred to as departure time) in the transfer destination. In the example illustrated in FIG. 4, “station X” is set to the attribute “transferLocation”, “18:11” is set to the attribute “arrivalTime”, “270 m” is set to the attribute “transferDistance”, “4.05 minutes” is set to the attribute “transferTime”, and “18:17” is set to the attribute “departureTime”. In the second boarding object 254 illustrated in FIG. 4, “route line C” is set to the attribute “line” and “station C8” is set to the attribute “to”. Lastly, the destination object 255 includes an attribute “destination” indicating the destination and an attribute “arrivalTime” indicating the arrival time to the destination. In the example illustrated in FIG. 4, “station C8” is set to the attribute “destination” and “18:48” is set to the attribute “arrivalTime”.

In the transfer object 253 exemplified in FIG. 4, the attribute “transferDistance” has a setting value of “270 m”, whereas the attribute “transferTime” has a setting value of “4.05 minutes”. This is derived from the walking condition that is in accordance with the status of the user and set by the search condition setting unit 203 being “low-speed walking” indicating the low-speed walking speed. In other words, when the walking condition that is set to the search condition included in the search request is “low-speed walking”, the route search server 30 uses, as a desired time in a walking section in transferring, the time that is calculated using the walking speed “66.66 m/minute” for the distance of the walking section. For example, when the walking condition set to the search condition is “standard walking”, the route search server 30 may set the time that is calculated using the walking speed “83.33 m/minute” for a distance of a walking section in transferring, as the desired time in the walking section. For example, when the walking condition set to the search condition is “high-speed walking”, the route search server 30 may set the time that is calculated using the walking speed “100 m/minute” for a distance of a walking section in transferring, as the desired time in the walking section. Noted that in the exemplification in FIG. 4, values of the station name, the time, the distance, and others that are set to the respective attributes are merely examples set for the explanation of the embodiment, and are not based on the fact.

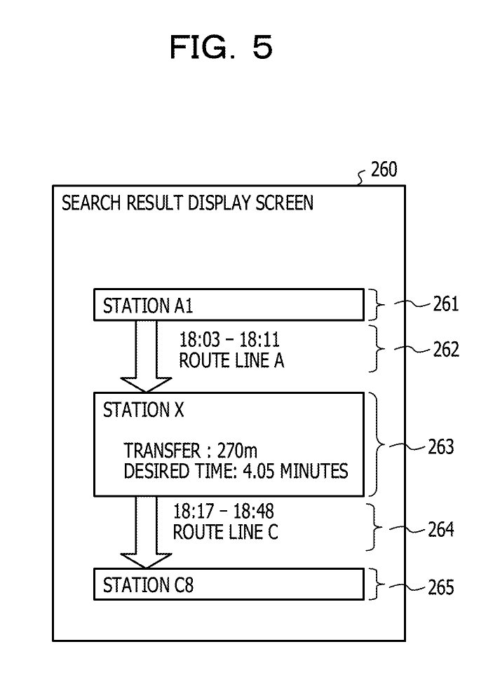

The search result displaying unit 206 is configured to display the route candidate included in the search result on the display of the terminal apparatus 20. FIG. 5 is a diagram illustrating one example of a search result display screen 260 that is displayed on the display of the terminal apparatus 20. The search result display screen 260 illustrated in FIG. 5 includes departure location information 261 indicating a departure location of the route candidate, boarding information 262 indicating a route line and a boarding time (combination of a departure expectation time and an arrival expectation time) used in the movement from the departure location to the next station, transfer information 263 indicating a next station of the departure location, and a distance and a desired time for transferring therein, second boarding information 264 indicating a route line after the transferring, and a boarding time (combination of a departure expectation time and an arrival expectation time) in the route line after the transferring, and destination information 265 indicating a destination of the route candidate. In the example illustrated in FIG. 5, the departure location information 261 is displayed based on a setting value of the attribute “currentLocation” of the departure location object 251. The first boarding information 262 is displayed based on a setting value of the attribute “departureTime” of the departure location object 251, a setting value of the attribute “arrivalTime” of the transfer object 253, and a setting value of the attribute “line” of the boarding object 252. The transfer information 263 is displayed based on a setting value of the attribute “to” of the first boarding object 252, a setting value of the attribute “transferDistance” of the transfer object 253, and a setting value of the attribute “transferTime” of the transfer object 253. The second boarding information 264 is displayed based on a setting value of the attribute “departureTime” of the transfer object 253, a setting value of the attribute “arrivalTime” of the destination object 255, and a setting value of the attribute “line” of the second boarding object 254. Lastly, the destination information 265 is displayed based on a setting value of the attribute “destination” of the destination object 255.

Next, a route search server is described. The route search server 30 illustrated in FIG. 2 is provided with a search request receiving unit 301, a route searching unit 302, a search result transmitting unit 303, the route search network database 304, and the station timetable database 305. Each function unit of the route search server 30 illustrated in FIG. 2 is implemented in such a manner that a processor included in the route search server 30 executes a program stored in a memory, for example. In other words, the processor of the route search server 30 executes the program stored in the memory accordingly to be converted into a circuit that implements each function unit of the route search server 30 illustrated in FIG. 2. Further, the route search network database 304 and the station timetable database 305 may be mounted to the apparatus that is the route search server 30, or may be mounted to another apparatus different from the route search server 30, and coupled so as to be accessible via the network 12 or a communication line different from the network 12.

The search request receiving unit 301 is configured to receive a search request that is transmitted from the terminal apparatus 20, and input the received search request into the route searching unit 302. The search request that is transmitted from the terminal apparatus 20 includes, as described above, a search condition set using the walking condition that is in accordance with the status of the user and determined based on the number of steps that the user of the terminal apparatus 20 has walked.

The route searching unit 302 is configured to, upon reception of a search request from the terminal apparatus 20 by the search request receiving unit 301, refer to the route search network database 304 and the station timetable database 305, and search a route candidate that satisfies the search condition included in the search request. Moreover, the route searching unit 302 inputs a search result including the searched route candidate into the search result transmitting unit 303. In the process of the route search, a known method called the label-correcting method or the Dijkstra method is used.

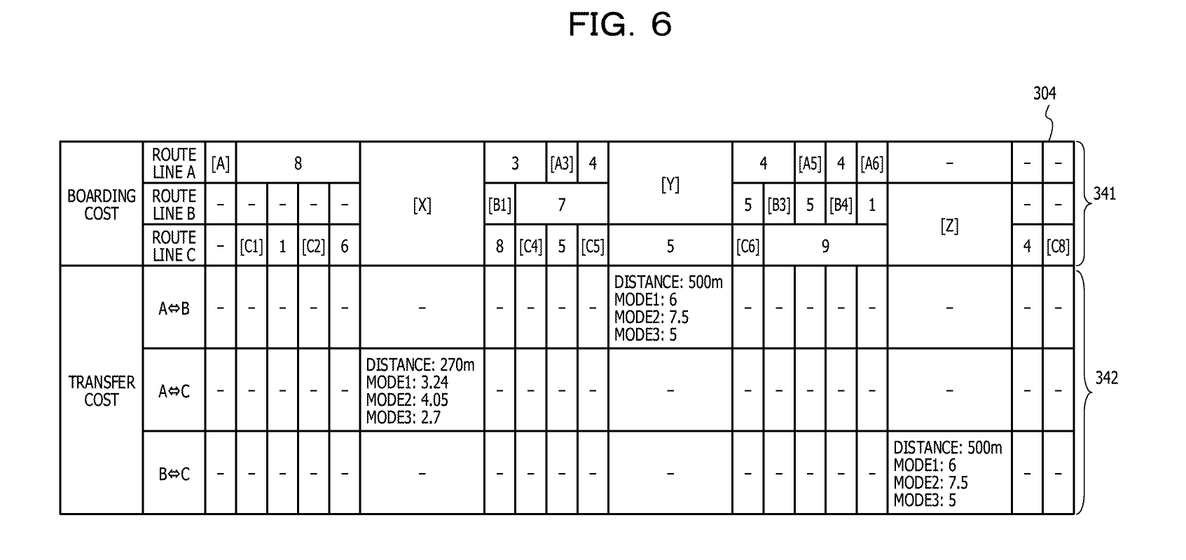

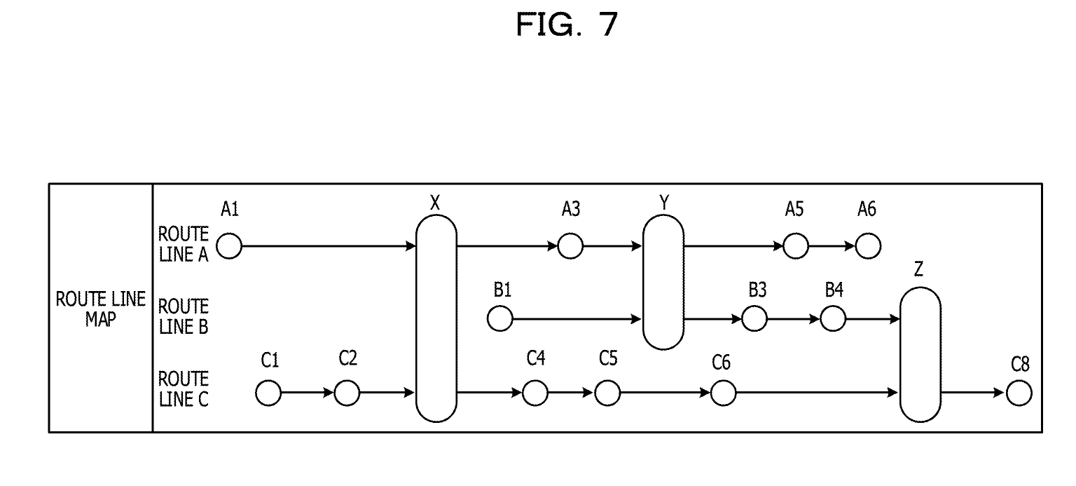

The route search network database 304 is a database in which when stations of the transport facilities serve as nodes, and route lines that connect the respective stations serve as links, boarding cost information (the desired time, the distance, the fee, and others between stations for every route line) on all the links is made to be a database, and further stores therein transfer cost information related to the transfer cost between the route lines at the transfer station. An overview of the route search network database 304 is described using FIGS. 6 and 7. FIG. 6 is a diagram schematically illustrating a content example of the route search network database 304. In the example illustrated in FIG. 6, data of route lines (three route lines of a route line A, a route line B, and a route line C) that are related to route candidates from a departure location A1 to a destination C8 is exemplified. FIG. 7 is a route line map schematically illustrating relations among the three route lines of the data stored in the route search network database 304 illustrated in FIG. 6. The route line A includes a station A1, a station X (also referred to as station A2), a station A3, a station Y (also referred to as station A4), a station A5, and a station A6. The route line B includes a station B1, the station Y (also referred to as station B2), a station B3, a station B4, and a station Z (also referred to as station B5). The route line C includes a station C1, a station C2, the station X (also referred to as station C3), a station C4, a station C5, a station C6, the station Z (also referred to as station C7), and a station C8. Further, the station X is a station that allows a transfer between the route line A and the route line C. The station Y is a station that allows a transfer between the route line A and the route line B. The station Z is a station that allows a transfer between the route line B and the route line C.

The route search network database 304 illustrated in FIG. 6 includes boarding cost information 341 and transfer cost information 342. In the boarding cost information 341, boarding costs (desired time, distance, fee, and others) between stations for every route line are set, and values each indicating the desired time between the stations, out of the boarding costs, are illustrated in the example illustrated in FIG. 6. For example, “8 minutes” is set as the desired time (boarding cost) from the station A1 to the station X of the route line A, and “3 minutes” is set as the desired time from the station X to the station A3 of the route line A.

In the transfer cost information 342, transfer costs between the route lines at the transfer station are set, and a distance of the walking section in transferring, and the desired time in accordance with each walking condition are illustrated in the example illustrated in FIG. 6. In the transfer cost information 342 illustrated in FIG. 6, as for the transfer station X, it is indicated that a transfer between the route line A and the route line C is possible, 270 m is set as a distance of the walking section in transferring, and as the desired time in accordance with the respective walking conditions, set are 3.24 minutes for the “standard walking” (Mode1), 4.05 minutes for the “low-speed walking” (Mode2), and 2.7 minutes for the “high-speed walking” (Mode3). As for the transfer station Y, it is indicated that a transfer between the route line A and the route line B is possible, 500 m is set as a distance of the walking section in transferring, and as the desired time in accordance with each walking condition, set are 6 minutes for the “standard walking” (Mode1), 7.5 minutes for the “low-speed walking” (Mode2), and 5 minutes for the “high-speed walking” (Mode3). Moreover, as for the transfer station Z, it is indicated that a transfer between the route line B and the route line C is possible, 500 m is set as a distance of the walking section in transferring, and as the desired time in accordance with each walking condition, set are 6 minutes for the “standard walking” (Mode1), 7.5 minutes for the “low-speed walking” (Mode2), and 5 minutes is set for the “high-speed walking” (Mode3).

For example, it is assumed that “station A1” of the route line A is set as a departure location of the search condition, and the station C8 “of the route line C is set as a destination”. The route searching unit 302 refers to the route search network database 304 to successively search a link from the node “station A1” of the departure location reaching the node “station C8” of the destination, and follow nodes and links with the minimum cost information of the link, and accordingly identifies, for example, the shortest route, as a route candidate from the departure location “station A1” to the destination “station C8”. As methods of such route search, a method called the label-correcting method or the Dijkstra method is used.

In the present embodiment, in the calculation of a transfer cost when links are successively searched, a transfer cost in accordance with the walking condition set to the search condition is referred. This allows the route searching unit 302 to search a route candidate such that the transfer section satisfies the walking condition that is in accordance with the status of the user and determined based on the number of steps of the user having measured by the terminal apparatus 20. In the example of FIG. 6, the route searching unit 302 is capable of searching, by successively searching links and nodes in the route search network database 304, as a route candidate from the departure location “station A1” to the destination “station C8”, two routes of a route (route AC) in a case of a transfer at the station X and a route (route ABC) in a case of a transfer at the station Y and the station Z. A cost AC of the route AC becomes, for example, AC=(A1→X)+(XAC)+(X→C4)+(C4→C5)+(C5→C6)+(C6→Z)+(Z→C8)=8+4.05+8+5+5+9+4=43.05. Here, as the cost XAC that is a transfer cost between the route line A and the route line C at the station X, the value “4.05” in accordance with the walking condition “low-speed walking” (Mode2) is referred. A cost ABC of the route ABC becomes, for example, ABC=(A1→X)+(X→A3)+(A3→Y)+(YAB)+(Y→B3)+(B3→B4)+(B4→Z)+(ZBC)+(Z→C8)=8+3+4+7.5+5+5+1+7.5+4=45. Here, as the cost YAB that is a transfer cost between the route line A and the route line B at the station Y, the value “7.5” in accordance with the walking condition “low-speed walking” (Mode2) is referred. Moreover, as the cost ZBC that is a transfer cost between the route line B and the route line C at the station Z, the value “7.5” in accordance with the walking condition “low-speed walking” (Mode2) is referred.

The route searching unit 302 determines that the cost AC of the route line AC is the minimum resulting from the comparison between the cost AC of the route line AC and the cost ABC of the route line ABC in the example of FIG. 6, and selects the route AC as the shortest route candidate that satisfies the search condition. The route searching unit 302 then inputs a search result including the shortest route candidate that satisfies the search condition into the search result transmitting unit 303. Note that, in the abovementioned simplified example, in the calculation of the cost of each route, an explanation of the waiting time before a boarding train departs at the transfer destination is omitted. For example, the route searching unit 302 may refer to the station timetable database 305 to retrieve the departure time of a boarding possible train at the transfer destination, and add the waiting time before the departure time comes to the cost. The station timetable database 305 is a database of the departure time of the trains at the stations of the respective route lines. The station timetable database 305 may store therein two types of the departure time for weekdays and for holidays, as the departure time of the train at each station, for the up line and the down line.

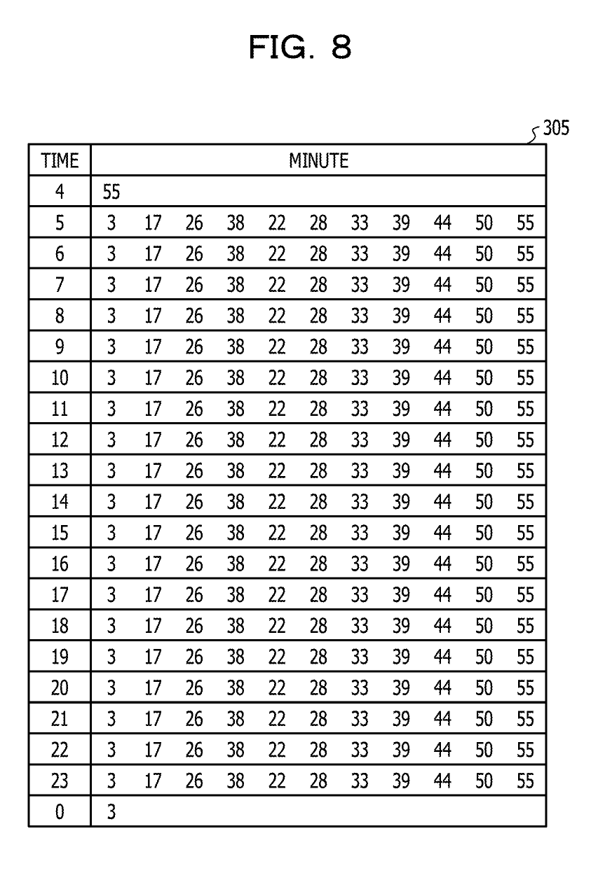

The search result transmitting unit 303 is configured to transmit a search result from the route searching unit 302 to the terminal apparatus 20 via the network 12. The content example the search result to be transmitted to the terminal apparatus 20 is illustrated in FIG. 4. In the content example of the search result illustrated in FIG. 4, the route searching unit 302 may retrieve the value of the departure time indicated by the attribute “departureTime” or the like, by referring to the station timetable database 305, for example. FIG. 8 is a diagram illustrating one example of the station timetable database 305 that stores therein the departure time of the train in the direction of the station C8 at the station X of the route line C. The route searching unit 302 may estimate the arrival time on the station X of the route line C as the transfer destination by adding the transfer cost in accordance with the walking condition to the arrival time on the station X of the route line A. The route searching unit 302 retrieves a train of the earliest departure time that allows boarding at the arrival time on the station X of the route line C as the transfer destination, by referring to the station timetable database 305. Here, it is assumed the arrival time on the station X of the route line A is “18:11”. Note that, the arrival time on the station X of the route line A may be identified by adding the desired time defined by the boarding cost from the station A1 to the station X, to the departure time of the train at the station A1 of the route line A. The route searching unit 302 calculates the arrival time “18:15.05” on the station X of the route line C as the transfer destination by adding the transfer cost “4.05” in accordance with the walking condition “low-speed walking” to the arrival time on the station X of the route line A. The route searching unit 302 may then obtain a departure time “18:17” at the station X of the route line C as the earliest departure time that allows boarding at the arrival time on the station X of the route line C as the transfer destination, by referring to the station timetable database 305 illustrated in FIG. 8. Also as for other stations, the use of the similar procedure allows the departure time and the arrival time to be identified.

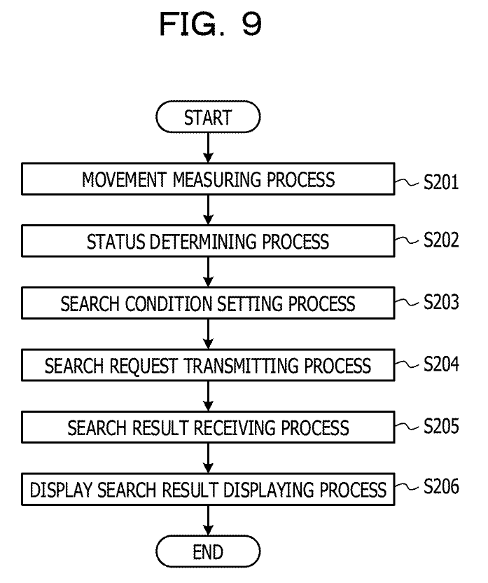

Next, one example of a flow of the process in each apparatus is briefly described. FIG. 9 is a flowchart illustrating one example of a flow of the process in the terminal apparatus 20 according to the first embodiment. In the flow of the process illustrated in FIG. 9, the process may be started using such a trigger that the terminal apparatus 20 displays the search condition input screen exemplified in FIG. 3 on the display of the terminal apparatus 20, for example. Alternatively, the process may be started using such a trigger that the user of the terminal apparatus 20 presses down the first search button or the second search button in the search condition input screen exemplified in FIG. 3.

The processor of the terminal apparatus 20 executes a movement measuring process (which may be referred to as “a process A-1”) to acquire a value (the measurement time number of steps) obtained by measuring the number of steps that the user has walked in the measurement target time (S201). Further, measuring and recording the number of steps (the unit time number of steps) for every measuring unit time by the movement measuring unit 201 may be executed all the time, independent of the flow of the process illustrated in FIG. 9.

The processor of the terminal apparatus 20 executes a status determining process (which may be referred to as “a process A-2”) to determine a walking condition indicating a current walking status of a user, based on the measurement time number of steps (S202). In the status determining process, when a threshold defined by a unit of speed is used, the processor of the terminal apparatus 20 may convert the measurement time number of steps into a walking speed based on a predetermined algorithm, and determine a walking condition indicating the walking status of the user by the comparison between the walking speed and one or more thresholds. Alternatively, when a threshold defined by a unit of the number of steps is used, the processor of the terminal apparatus 20 may determine a walking condition indicating the walking status of the user by the comparison between the measurement time number of steps and one or more thresholds. Noted that the statement “determining a walking condition indicating a current walking status of a user based on the measurement time number of steps” is used as a concept that includes not only directly determining a walking condition from the measurement time number of steps, but also determining a walking condition based on a value obtained by converting the measurement time number of steps into another index value such as the walking speed. Note that, for example, a pace of the user may be used for the conversion from the measurement time number of steps into the walking speed. For example, the walking speed V can be calculated from V=measurement time number of steps×pace/measurement target time. Moreover, as for the pace of the user, a value of the pace may be inputted in advance by the user, the pace may be calculated from the height of the user that is set in advance using a predetermined algorithm, or an average value of the pace may be set when the terminal apparatus 20 is manufactured and the like. As a method of converting the height into the pace, for example, a method of subtracting 1 [m] from the height [m] may be used, or a method of multiply the height [m] by a predetermined coefficient (for example, 0.4) may be used. In the status determining process, the processor of the terminal apparatus 20 selects, as the walking condition indicating the walking status of the user that is determined based on the measurement time number of steps, for example, any one of the “standard walking”, the “low-speed walking”, and the “high-speed walking”. Note that, a specific example of the threshold used in the determination is described in the above, and thus an explanation thereof is omitted.

The processor of the terminal apparatus 20 executes a search condition setting process (which may be referred to as “a process A-3”) to set information related to the movement of the user that is determined based on information related to the walking condition of the user, to a search condition including a departure location and a destination (S203). Further, the search condition may include the departure time. Moreover, the user may be caused to input, out of the setting items of the search condition, the setting items other than the walking condition, using the search condition input screen 230 illustrated in FIG. 3. The processor of the terminal apparatus 20 executes a search request transmitting process (which may be referred to as “a process A-4”) to transmit the search request to the route search server 30 (S204). In the search request transmitting process, the processor of the terminal apparatus 20 transmits a search request including the search condition to which the information related to the walking condition that is determined based on the information related to the movement of the user is set, to the route search server 30 via the network 12.

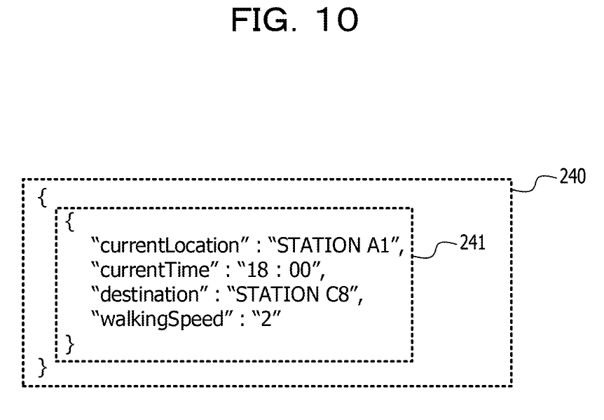

FIG. 10 is a diagram illustrating a content example of a search request that is transmitted from the terminal apparatus 20 to the route search server 30. A search request 240 illustrated in FIG. 10 is written in Java Script Object Notation (JSON), and includes a search condition object 241. The search condition object 241 includes an attribute “currentLocation” indicating the departure location, an attribute “currentTime” indicating the current time, an attribute “destination” indicating the destination, and an attribute “walkingSpeed” indicating the walking condition. In the example illustrated in FIG. 10, “station A1” is set to the attribute “currentLocation”, “18:00” is set to the attribute “currentTime”, “station C8” is set to the attribute “destination”, and an index value “2” indicating the “low-speed walking” is set to the attribute “walkingSpeed”.

The description returns to the explanation for FIG. 9. The processor of the terminal apparatus 20 executes, after the process S204, a search result receiving process (which may be referred to as “a process A-5”) to receive a search result including a route candidate that satisfies the search condition, from the route search server 30 (S205). The content example of the search result is illustrated in FIG. 4. The processor of the terminal apparatus 20 executes, after the process S205, a search result displaying process (which may be referred to as “a process A-6”) to display the route candidate included in the search result having received from the route search server 30 (S206).

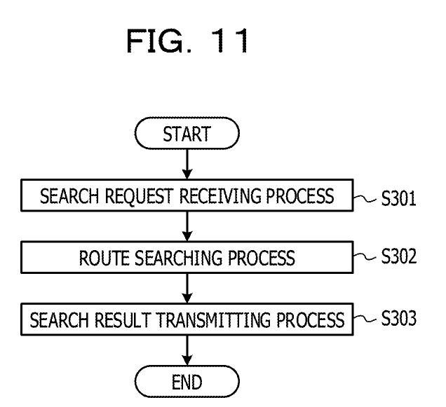

Next, one example of a flow of the process of the route search server 30 is briefly described using FIG. 11. FIG. 11 is a flowchart illustrating one example of a flow of the process of the route search server 30 according to the first embodiment. In the flow of the process illustrated in FIG. 11, the process may be started using such a trigger that the route search server 30 detects the reception of a signal via the network 12 from the terminal apparatus 20, for example.

The processor of route search server 30 executes a search request receiving process to receive a search request from the terminal apparatus 20 (S301). Noted that the statement “receiving a search request from the terminal apparatus 20” in the search request receiving process is used as a concept that includes acquiring data in a format that the processor is capable of interpreting as a search request, by decoding a reception signal in accordance with a predetermined protocol, in the reception of the signal via the network 12 from the terminal apparatus 20 in the process illustrated in FIG. 11, which is exemplified as a start trigger. The content example of the search request is illustrated in FIG. 10.

The processor of the route search server 30 executes, after the process S301, a route searching process to search a route candidate including a departure location and a destination indicated by the search condition (S302). In the route searching process, the processor of the route search server 30 searches a route candidate that satisfies the search condition by referring to the route search network database 304 and the station timetable database 305. When the search route includes a transfer section (walking section), the processor of the route search server 30 searches a route candidate such that the walking section satisfies the walking condition in accordance with the walking status of the user. In the route searching process, the processor of the route search server 30 selects, for example, the route with the minimum cost as a route candidate, out of the routes that satisfy the search condition, and creates a search result including the route candidate. A specific example thereof is described in the above, and thus an explanation thereof is omitted.

The processor of the route search server 30 executes a search result transmitting process to transmit the search result including the route candidate, to the terminal apparatus 20 via the network 12 (S303). The content example of the search result is illustrated in FIG. 4.

The first embodiment has been explained in the foregoing. With the first embodiment, a search condition may be automatically set using the walking condition that is in accordance with the walking status of the user and determined based on the information related to the movement of the user (for example, the measurement value of the number of steps that the user has walked). This makes it possible to allow the route retrieval server, when retrieving a route candidate including a transfer section, to search a route candidate such that the transfer section satisfies the walking condition in accordance with the walking status of the user. This allows an optimal route guidance in accordance with the status of the user while reducing a burden of the input operation on the user.

### Second Embodiment

Next, a second embodiment is described. In the abovementioned the first embodiment, as for a transfer cost value that is referred in the route searching process by the route search server 30, a cost value for every walking condition in accordance with the status of the user is referred. Meanwhile, as for a cost value for every walking condition, used is not a value calculated using the actual walking speed of the user but a value that is designed using a walking speed (assumed walking speed) assumed in advance. This makes it more difficult to ignore an error of the desired time in the walking section included in the search result as a divergence between the actual walking speed of the user and the assumed walking speed becomes larger. Therefore, in the second embodiment, added is a search result correcting process (which may be referred to as “a process A-7”) to determine, in accordance with the degree of a divergence between the actual walking speed of the user and the assumed walking speed, in other words, based on the degree of a divergence between the determination result in the status determining process (S202) and the actual walking speed of the user, whether correction of the search result is requested, and if requested, correct the search result using the actual walking speed.

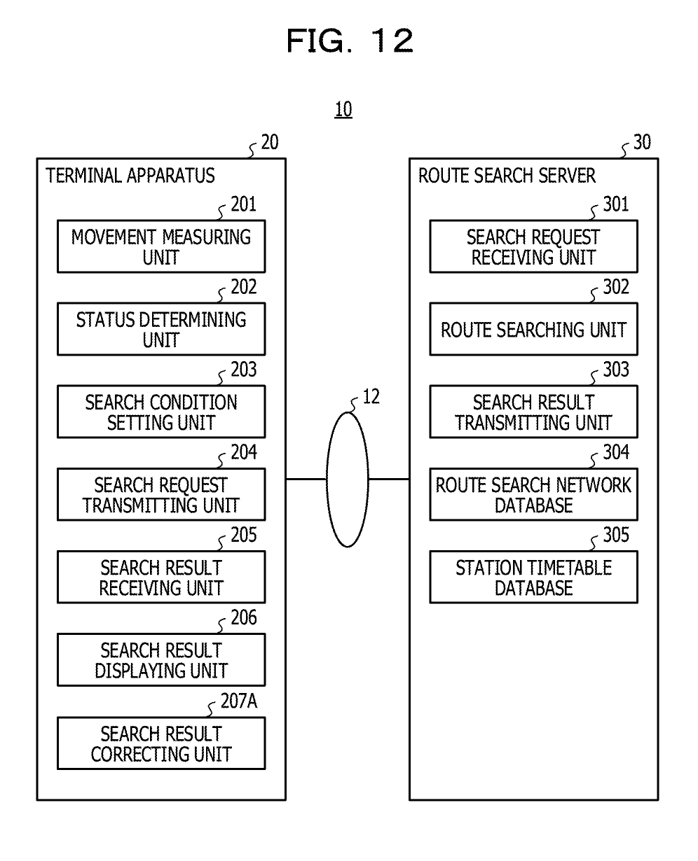

FIG. 12 is a block diagram illustrating the detailed configuration of the route search system 10 according to the second embodiment. The configuration of the route search system 10 illustrated in FIG. 12 is different from that of the route search system 10 according to the first embodiment illustrated in FIG. 2 in that a search result correcting unit 207A is added in the terminal apparatus 20, but is similar in others.

The search result correcting unit 207A of the terminal apparatus 20 is configured to correct, when a difference between the walking speed of the user and any of one or more thresholds is a predetermined value or more, the desired time of the walking section in the route candidate included in the search result having received from the route search server 30, based on the walking speed of the user. Further, similar to other function units, the search result correcting unit 207A is implemented in such a manner that the processor of the terminal apparatus 20 executes a program stored in the memory. In other words, the processor of the terminal apparatus 20 executes the program stored in the memory accordingly to be converted into a circuit that implements each function unit of the terminal apparatus 20 illustrated in FIG. 12.

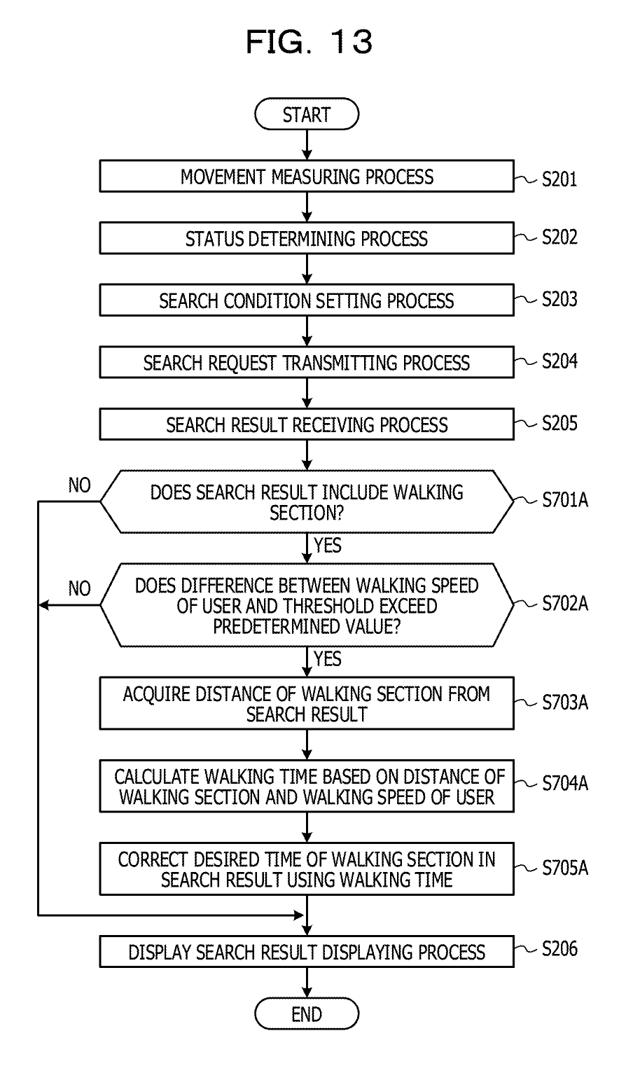

FIG. 13 is a flowchart illustrating one example of a flow of the process in the terminal apparatus 20 according to the second embodiment. The flow of the process illustrated in FIG. 13 is different from the flow of the process illustrated in FIG. 9 in that a process S701A to a process S705A are added, as a process related to the search result correcting unit 207A, between the search result receiving process (S205) and the search result displaying process (S206), but is similar thereto in others. Hereinafter, the process related to the search result correcting unit 207A is mainly explained, and explanations for other processes are similar to those for FIG. 9 and thus are omitted as appropriate.

After receiving a search result at the search result receiving process (S205), the processor of the terminal apparatus 20 determines whether a route candidate indicated in the search result includes the walking section (S701A). At the process S701A, the processor of the terminal apparatus 20 refers to the search result, and determines whether the route candidate includes the transfer object 253. In the example illustrated in FIG. 4, the transfer object 253 includes the attribute “transferLocation”, the attribute “arrivalTime”, the attribute “transferDistance”, the attribute “transferTime”, and the attribute “departureTime”. Therefore, the processor of the terminal apparatus 20 retrieves an object including these attributes, out of the objects included in the route candidate, and thus may determine the presence or absence of the transfer object 253. The processor of the terminal apparatus 20 may determine the presence or absence of the transfer object 253 by other methods. For example, the processor of the terminal apparatus 20 may determine the presence or absence of the transfer object 253 by defining an attribute indicating the type of each object, in various kinds of objects included in the route candidate, and referring to a setting value of the attribute indicating the type of the object.

At the process S701A, if detecting that the route candidate in the search result does not include the transfer object 253, the processor of the terminal apparatus 20 may determine that the search result does not include the walking section (NO at S701A). In this case (NO at S701A), the processor of the terminal apparatus 20 may execute the search result displaying process (S206) without correcting the search result.

In contrast, at the process S701A, if detecting that the route candidate in the search result includes the transfer object 253, the processor of the terminal apparatus 20 may determine that the search result includes the walking section (YES at S701A). In this case (YES at S701A), the processor of the terminal apparatus 20 checks whether the degree of divergence between the determination result in the status determining process (S202) and the walking speed of the user is to the extent that has to be corrected (S702A). In other words, the processor of the terminal apparatus 20 calculates a difference between the threshold used in the status determining process (S202) and the walking speed of the user, and determines whether the difference value exceeds a predetermined value (for example, 30 m/minute) (S702A). For example, when the status of the user (walking condition of the user) selected in the status determining process (S202) is the “low-speed walking”, the processor of the terminal apparatus 20 may calculate a difference between a second threshold that defines a boundary between the “standard walking” and the “low-speed walking”, and the walking speed of the user, at the process S702A. Moreover, for example, when the status of the user (walking condition of the user) selected in the status determining process (S202) is the “high-speed walking”, the processor of the terminal apparatus 20 may calculate a difference between a first threshold that defines a boundary between the “standard walking” and the “high-speed walking”, and the walking speed of the user, at the process S702A. Further, when the status of the user (walking condition of the user) selected in the status determining process (S202) is the “standard walking”, the processor of the terminal apparatus 20 may execute the search result displaying process (S206) without correcting the search result. This is because the “standard walking” is a walking speed within a range that is sectioned by the first threshold and the second threshold, and thus is capable of being considered that the degree of divergence between the determination result in the status determining process (S202) and the walking speed of the user does not reach the extent that has to be corrected.

At the process S702A, if determining that the calculated difference value does not exceed the predetermined value (NO at S702A), the processor of the terminal apparatus 20 may execute the search result displaying process (S206) without correcting the search result. This is because the degree of divergence between the determination result in the status determining process (S202) and the walking speed of the user does not reach the extent that has to be corrected.

If determining that the calculated difference value exceeds the predetermined value at the process S702A (YES at 5702A), the processor of the terminal apparatus 20 acquires a distance of the walking section from the search result (S703A). At the process S703A, the processor of the terminal apparatus 20 may acquire a distance of the walking section by referring to a setting value of the attribute “transferDistance” of the transfer object 253 from the route candidate of the search result.

The processor of the terminal apparatus 20 calculates the walking time (also referred to as the desired time of the walking section) based on the distance of the walking section and the walking speed of the user (S704A). For example, a walking time TA may be calculated by TA=distance of walking section/walking speed.

The processor of the terminal apparatus 20 corrects the desired time of the walking section in the search result using the walking time TA (S705A). At the process S705A, the processor of the terminal apparatus 20 corrects the search result by overwriting the setting value of the attribute “transferDistance” of the transfer object 253 from the route candidate of the search result with the calculated walking time TA, for example. This allows the processor of the terminal apparatus 20 to display the search result corrected using the walking speed of the user on the display, at the search result displaying process (S206).

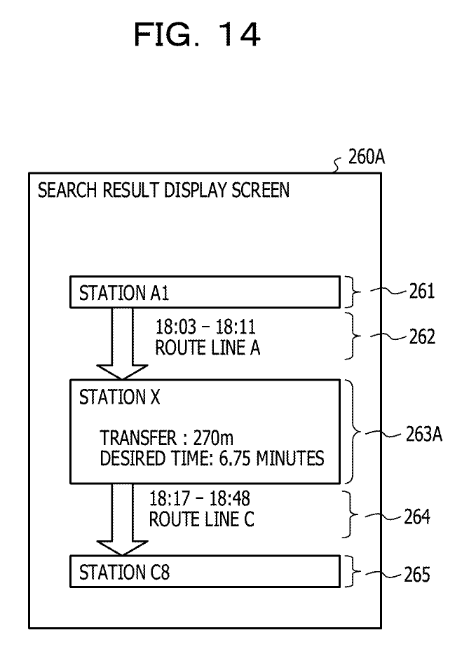

FIG. 14 is a diagram illustrating one example of a search result display screen 260A on which a search result corrected based on the walking speed of the user is displayed. In FIG. 14, the search result display screen 260A is different from the search result display screen 260 illustrated in FIG. 5 in that the content of transfer information 263A is changed, but is similar thereto in others. The desired time is corrected to “6.75 minutes” in the transfer information 263A illustrated in FIG. 14. This is a correction value when the walking speed of the user is “40 m/minute”. In other words, the desired time TA after the correction may be acquired by calculating TA=transfer distance “270 m”/walking speed of the user “40 m/minute”=“6.75 minutes”. Although the example in which a value that is included in the search result having received from the route search server 30 is overwritten with that of the desired time after the correction in the screen example illustrated in FIG. 14, the present embodiment is not limited thereto. For example, the desired time after the correction may be additionally displayed as supplementary information while the value that is included in the search result having received from the route search server 30 is remained. In this case, the desired time of the transfer information 263A may be displayed, for example, “desired time:4.05 minutes (estimation with current walking pace: 6.75 minutes)”. This allows the user to recognize that he/she has to walk at the speed slightly faster than the current walking speed for the transfer by referring to the search result display screen after the correction.

The second embodiment has been explained in the foregoing. With the second embodiment, when the degree of divergence between the determination result in the status determining process (S202) and the walking speed of the user does has an extent that has to be corrected, a search result from the route search server 30 may be corrected, and the estimation of the desired time of the walking section included in the route candidate may be displayed as a suitable value.

### Third Embodiment

Next, a third embodiment is described. In the abovementioned second embodiment, the desired time of the walking section in the search result is corrected based on the actual walking speed, if requested. However, there is a case where the user may apparently be late for the departure time of the train after the transferring, depending on the desired time after the correction. In that case, the user has to perform an operation of again inputting a new search condition, and transmitting a search request. Therefore, in the third embodiment, added is a series of processes to determine whether the user is in time for the departure time of the train after the transferring when the search result is corrected based on the actual walking speed, a re-search is requested when the user is apparently late, and the search result is corrected using a result of the re-search (hereinafter, also referred to as second search result).

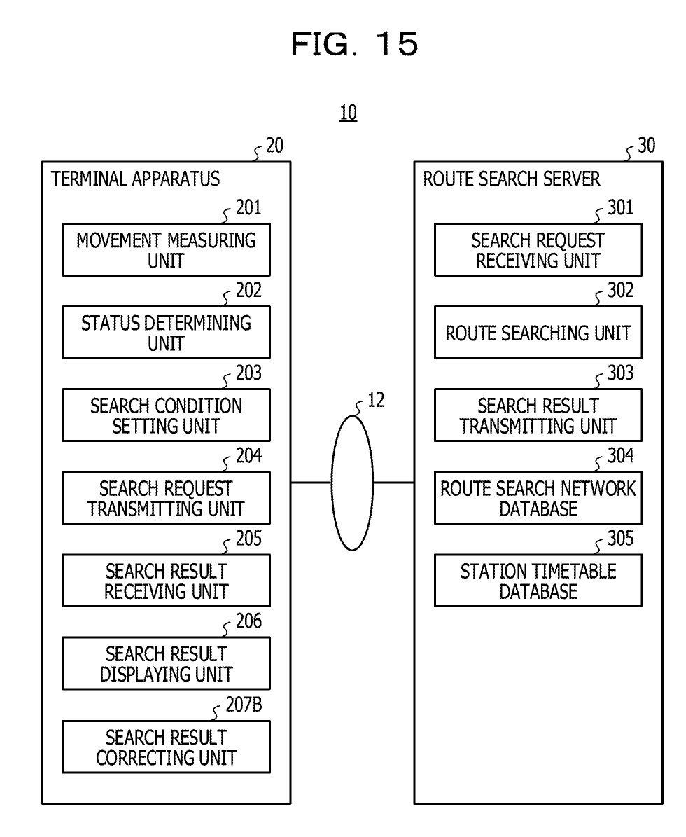

FIG. 15 is a block diagram illustrating the detailed configuration of the route search system 10 according to the third embodiment. The configuration of the route search system 10 illustrated in FIG. 15 is different from that of the route search system 10 according to the first embodiment illustrated in FIG. 2 in that a search result correcting unit 207B is added in the terminal apparatus 20, but is similar in others.

The search result correcting unit 207B of the terminal apparatus 20 is configured to add the following process to the search result correcting unit 207A according to the second embodiment. In other words, when correcting the desired time of the walking section in the route candidate included in the search result having received from the route search server 30 based on the walking speed of the user, the search result correcting unit 207B of the terminal apparatus 20 determines whether the user is in time for the departure time of the train after the transferring, based on the desired time after the correction. If it is determined that the user is not in time, the search result correcting unit 207B of the terminal apparatus 20 requests a re-search of a route subsequent to the transferring of the route search server 30, using a new departure time (also referred to as departure start time) based on the desired time after the correction (also referred to as walking time after the correction). Upon receiving a result of the re-search request from the route search server 30, the search result correcting unit 207B corrects the search result using the result of the re-search request. The search result correcting unit 207B of the terminal apparatus 20 is configured to add a series of these processes to the search result correcting unit 207A according to the second embodiment. Further, similar to other function units, the search result correcting unit 207B is implemented in such a manner that the processor of the terminal apparatus 20 executes a program stored in the memory. In other words, the processor of the terminal apparatus 20 executes the program stored in the memory accordingly to be converted into a circuit that implements each function unit of the terminal apparatus 20 illustrated in FIG. 15.

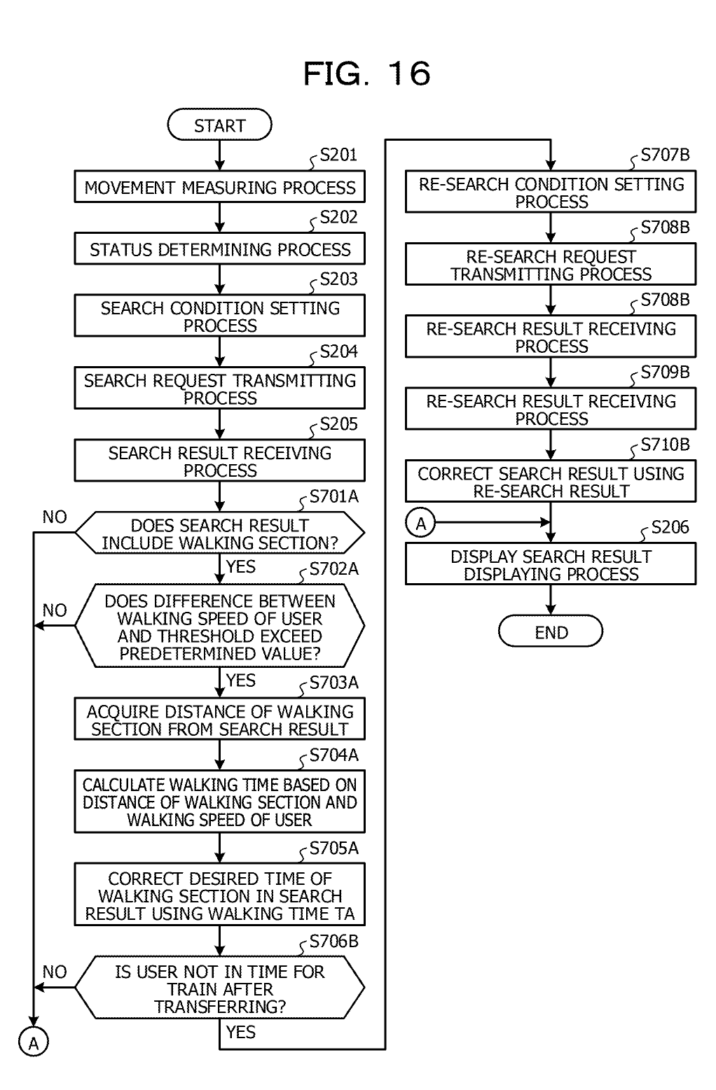

FIG. 16 is a flowchart illustrating one example of a flow of the process in the terminal apparatus 20 according to the third embodiment. The flow of the process illustrated in FIG. 16 is different from the flow of the process illustrated in FIG. 13 in that a process S706B to a process S710B are added between the processes (S701A to S705A) related to the search result correcting unit 207A after the search result receiving process (S205) and the search result displaying process (S206), but is similar thereto in others. Hereinafter, a series of processes from the process S706B to the process S710B added in the third embodiment is mainly explained, and explanations for other processes are similar to those for FIG. 9 and FIG. 13 and thus are omitted as appropriate.

When correcting the desired time of the walking section in the search result in the search result correcting processes (S701A to S705A) after receiving the search result in search result receiving process (S205), the processor of the terminal apparatus 20 determines whether the user is in time for a train after the transferring (S706B). At the process S706B, the processor of the terminal apparatus 20 calculates, using the desired time after the correction of the walking section in the search result and the arrival expectation time on the start location of the walking section (also referred to as start location expectation time), an arrival expectation time on an end location of the walking section (also referred to as end location expectation time), and determines whether the user is in time for a departure scheduled time of a train after the transferring. The processor of the terminal apparatus 20 may acquire the arrival expectation time to the start location of the walking section (start location expectation time) by referring to a setting value of the attribute “arrivalTime” of the transfer object 253 included in the route candidate of the search result, for example. Moreover, the processor of the terminal apparatus 20 may acquire the end location expectation time by adding the desired time corrected at the process S705A to the start location expectation time. Further, when acquiring the end location expectation time, the processor of the terminal apparatus 20 may round off fractions of the second bit to the minute bit. For example, when the desired time after the correction is “6.75 minutes” and the start location expectation time is “18:11”, “0.75” as fractions of the second bit is rounded off to the minute bit, and the end location expectation time of “18:18” may be obtained. The processor of the terminal apparatus 20 may acquire the departure scheduled time of the train after the transferring by referring to a setting value of the attribute “departureTime” of the transfer object 253 included in the route candidate of the search result, for example.

At the process S706B, if the end location expectation time does not exceed the departure scheduled time of the train after the transferring, the processor of the terminal apparatus 20 may determine that the user is in time for the train after the transferring (NO at S706B). In this case (NO at S706B), the processor of the terminal apparatus 20 may execute the search result displaying process (S206) without executing the process of the re-search request of the train after the transferring (S707B to S710B).

In contrast, at the process S706B, if the end location expectation time exceeds the departure scheduled time of the train after the transferring, the processor of the terminal apparatus 20 may determine that the user is not in time for the train after the transferring (YES at 5706B). In this case (YES at S706B), the processor of the terminal apparatus 20 executes a process to set a re-search condition (also referred to as second search condition) (S707B) in order to search a new departure time of a boarding possible train after the transferring. At the process S707B, the processor of the terminal apparatus 20 may acquire a boarding station after the transferring by referring to a setting value of the attribute “transferLocation” of the transfer object 253 included in the route candidate of the search result, for example. The processor of the terminal apparatus 20 may set the acquired boarding station after the transferring to an attribute “currentLocation” of a re-search condition object 241B in a re-search request 240B. Moreover, the processor of the terminal apparatus 20 may acquire a getting-off station of the destination by referring to a setting value of the attribute “destination” of the destination object 255 included in the route candidate of the search result, for example. The processor of the terminal apparatus 20 may set the acquired getting-off station of the destination to an attribute “destination” of the re-search condition object 241B in the re-search request 240B. Further, at the process S707B, the processor of the terminal apparatus 20 may set the end location expectation time acquired at the process S706B to the attribute “currentTime” of the re-search condition object 241B in the re-search request 240B. In addition, the processor of the terminal apparatus 20 may set the same value as the value of the walking condition set to the search request at the process S203, to the attribute “walkingSpeed” of the re-search condition object 241B in the re-search request 240B.

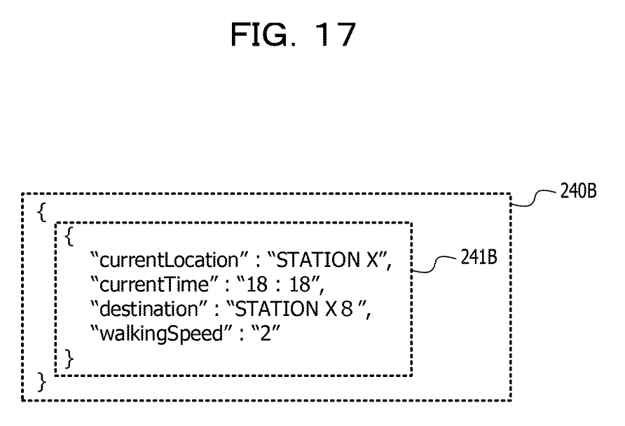

The processor of the terminal apparatus 20 transmits a re-search request including the re-search condition object 241B set at the abovementioned process S707B, to the route search server 30 (S708B). Further, the route search server 30 does not have to distinguish the re-search request transmitted at the process S708B from the search request transmitted at the process S204. In other words, when receiving a re-search request, the route search server 30 searches a route candidate that satisfies the re-search condition similar to the case of the search request, and transmits a re-search result (also referred to as second search result) to the terminal apparatus 20. FIG. 17 is a diagram illustrating a content example of the re-search request 240B. The re-search request 240B illustrated in FIG. 17 is written in Java Script Object Notation (JSON), and in the re-search condition object 241B, “station X” that is a station after the transferring is set to the attribute “currentLocation”, “18:18” that is an end location expectation time is set to the attribute “currentTime”, “station C8” that is a getting-off station of the destination is set to the attribute “destination”, and “2” that is an index value of the walking condition indicating the “low-speed walking” is set to the attribute “walkingSpeed”. The abovementioned re-search condition object 241B allows a re-search to be requested by setting routes subsequent to the walking section in the route candidate included in the search result that is set as a main in the abovementioned process S205, as a re-search target route.

The route search server 30 having received the re-search request refers to the route search network database 304 illustrated in FIG. 6, and acquires a candidate route by the route searching process S302 illustrated in FIG. 11. In that case, the processor of the route search server 30 refers to the station timetable database 305 that stores therein the departure time of the train in the direction of a station C8 at the station X of the route line C and exemplified in FIG. 8 at the station X of the route line C to retrieve a train having the earliest departure time after “18:18” that is set to attribute “currentTime” of the re-search condition object 241B included in the re-search request 240B, and thus may identify a train the departure time of which is “18:26”.

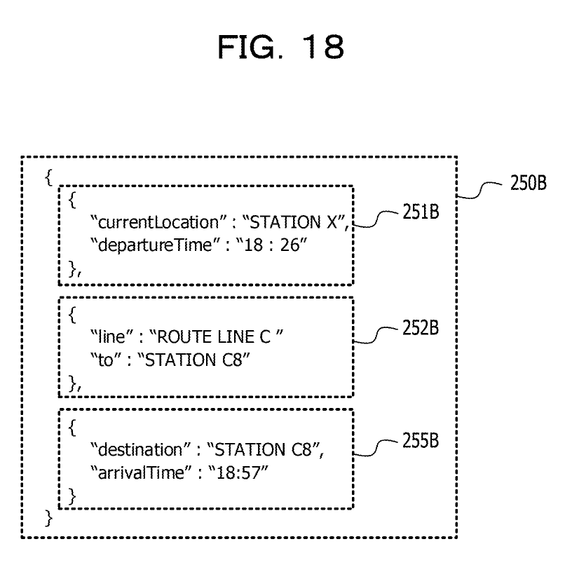

The processor of the terminal apparatus 20 receives a re-search result including the route candidate that satisfies the re-search condition, from the route search server 30 (S709B). FIG. 18 is a diagram illustrating a content example of a re-search result 250B. The re-search result 250B illustrated in FIG. 18 is written in Java Script Object Notation (JSON) format, and includes one route candidate configured by a departure location object 251B, a boarding object 252B, and a destination object 255B. “Station X” that is a boarding station after the transferring is set to the attribute “currentLocation” of the departure location object 251B, and “18:26” that is the departure scheduled time of the boarding possible train after the transferring is set to the attribute “departureTime” thereof. This makes it possible to acquire the departure scheduled time of the boarding possible train depending on the actual walking speed of the user. Moreover, “route line C” that is a boarding route line after the transferring is set to the attribute “line” of the boarding object 252B, and “station C8” that is a getting-off station of route line C after the transferring is set to the attribute “to” thereof. In the destination object 255B, “station C8” that is a getting-off station of the destination is set to the attribute “destination”, and “18:57” that is an arrival expectation time to the destination is set to the attribute “arrivalTime” thereof.

The processor of the terminal apparatus 20 further corrects the search result 250 corrected at the process S705A using a route candidate included in the re-search result 250B acquired at the process S709B, and acquires a search result 250C after the correction (S710B). At the process S710B, the processor of the terminal apparatus 20 corrects, using the attribute “departureTime” of the departure location object 251B in the re-search result 250B, the attribute “departureTIme” of the transfer object 253 in the search result 250 to “18:26”. Noted that the attribute “transferTime” of the transfer object 253 in the search result 250 is corrected to “6.75 minutes” that is the desired time based on the walking speed of the user, by the process S705A. At the process S710B, the processor of the terminal apparatus 20 corrects the boarding object 254 in the search result 250, using the boarding object 252B in the re-search result 250B. At the process S710B, the processor of the terminal apparatus 20 corrects the boarding object 252 in the search result 250, using the boarding object 252B in the re-search result 250B. With the corrections in the forgoing, the processor of the terminal apparatus 20 acquire the search result 250C after the correction.

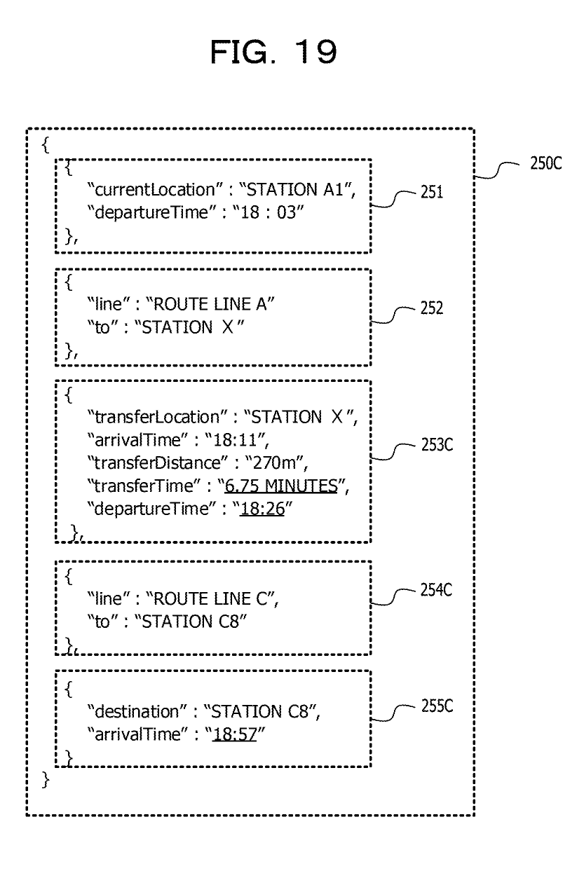

FIG. 19 is a diagram illustrating a content example of a search result 250C after the correction. In the search result 250C after the correction illustrated in FIG. 19, items in the content example of the search result illustrated in FIG. 4 the value of which is changed due to the correction at the process S710B are underlined. In other words, in the search result 250C after the correction, the attribute “transferTime” of a transfer object 253C is changed from “4.05 minutes” to “6.75 minutes”, and the attribute “departureTime” thereof is changed from “18:17” to “18:26”. Moreover, the attribute “arrivalTime” of a transfer object 255C in the search result 250C after the correction is changed from “18:48” to “18:57”.

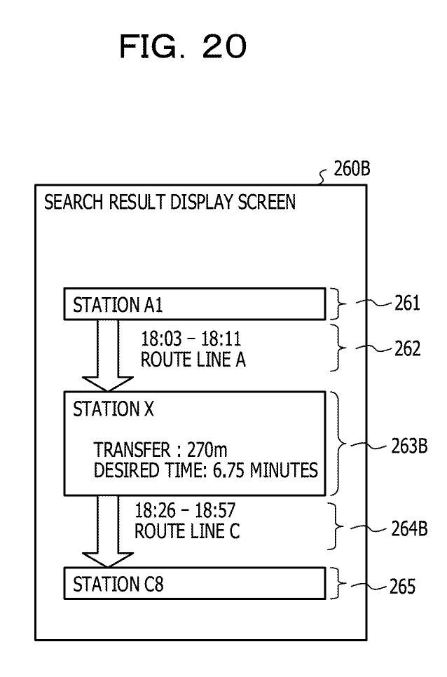

FIG. 20 is a diagram illustrating one example of a search result display screen 260B that is displayed based on the search result 250C after the correction. In FIG. 20, the search result display screen 260B is different from the search result display screen 260 illustrated in FIG. 5 in that the contents of transfer information 263B and boarding information 264B are changed, but is similar thereto in others. Moreover, the search result display screen 260B illustrated in FIG. 20 is different from the search result display screen 260A illustrated in FIG. 14 in that the content of the boarding information 264B is changed, but is similar thereto in others. In other words, the desired time is corrected to “6.75 minutes” in the transfer information 263B illustrated in FIG. 20. This is a correction value when the walking speed of the user is “40 m/minute”. In other words, the desired time TA after the correction may be acquired by calculating TA=transfer distance “270 m”/walking speed of the user “40 m/minute”=“6.75 minutes”. Moreover, in the boarding information 264B illustrated in FIG. 20, the departure scheduled time of the train in the route line C after the transferring is corrected to “18:26”, and the arrival expectation time at the getting-off station “station C8” is corrected to “18:57”. These allow the route candidate that the user is sufficiently in time with the walking condition in accordance with the status of the user to be displayed.

Although the example in which only one transfer object is included in the search result has been explained in the abovementioned explanation, when the search result includes two or more transfer objects, a transfer object closer to the departure location is in sequentially taken out, and the correcting process (S701A to S710B) based on information on the search result including from each transfer object to the destination object may recursively be executed.

The third embodiment has been explained in the foregoing. With the third embodiment, the desired time of the walking section in the search result is corrected based on the actual walking speed, and an optimal route candidate using the departure scheduled time of the train for which the user is sufficiently in time with the actual walking speed may be displayed.

<First Modification>

Although the examples in which the status determining unit 202 is mounted to the terminal apparatus 20 have been explained in the abovementioned embodiments, the status determining unit 202 may be mounted to the route search server 30. In this case, the search condition setting unit 203 may set, for example, a value indicating the measurement time number of steps acquired from the movement measuring unit 201 or a value indicating the walking speed acquired based on the measurement time number of steps, as the attribute “walkingSpeed” of the search condition object. Hereinafter, a concept including the value indicating the measurement time number of steps acquired from the movement measuring unit 201 and/or the measurement time number of steps is also referred to as information related to the movement of the user. The route search server 30 may acquire a walking condition classified into a predetermined stage by performing the threshold determination of a value indicated in the attribute “walkingSpeed” of the search condition object in the search request received from the terminal apparatus 20 with the similar procedure to the status determining process S202, and execute the route searching process based on the acquired walking condition.

The route search server 30 according to a first modification is provided with a search request receiving unit (which may be referred to as “a process B-1”, “a search request receiving process”) that receives, from a terminal apparatus that measures information related to the movement of a user (for example, the number of steps that the user has walked), a search request including a search condition to which information related to movement of a user measured within a predetermined period of time, and a departure location and a destination are set, a status determining unit (which may be referred to as “a process B-2”, “a status determining process”) that determines the status of the user (walking condition of the user) based on information related to the movement of the user set to the search condition included in the search request having received from the terminal apparatus, a route searching unit (which may be referred to as “a process B-3”, “a route searching process”) that searches a route candidate that satisfies the departure location and destination set in the search condition, when the route candidate includes a transfer section, a route candidate including a transfer section that satisfies the walking condition in accordance with the status of the user obtained by the determination, and a search result transmitting unit (which may be referred to as “a process B-4”, “a search result transmitting process”) that transmits a search result including the route candidate searched by the route searching unit, to the terminal apparatus.

<Second Modification>

Although the example in which the search result correcting unit 207A is mounted to the terminal apparatus 20 has been explained in the abovementioned second embodiment, the search result correcting unit 207A may be mounted to the route search server 30. In this case, the terminal apparatus 20 may simply store, as similar to the abovementioned first modification or by other methods, a value indicating the measurement time number of steps and/or value indicating the walking speed of the user in a search request, and transmit the search request to the route search server 30. The route search server 30 may simply acquire the value indicating the measurement time number of steps and/or the value indicating the walking speed of the user, in response to the search request from the terminal apparatus 20, and correct, with the procedure similar to the search result correcting processes S701A to S705A illustrated in FIG. 13, a value of an attribute “transferTime” of the transfer object 253 in the search result, at the route searching process S302.

In the route search server 30 according to a second modification, in addition to the configuration indicated in the abovementioned first modification, the number of steps of the user or the walking speed of the user measured within a predetermined period of time are set to the search request received from the terminal apparatus by the search request receiving unit, as the information related to the movement of the user. The status determining unit is configured to determine the walking condition indicating the status of the user by comparing the number of steps or the walking speed of the user that is acquired from the search request having received from the terminal apparatus with one or more thresholds. Further, the route search server 30 according to the second modification is further provided with a search result correcting unit (which may be referred to as “a process B-5”, “a search result correcting process”) that corrects, if a difference between the number of steps or the walking speed of the user that is acquired from the search request having received from terminal apparatus and one or more thresholds is a predetermined value or more, the desired time of the walking section in the route candidate searched by the abovementioned route searching unit based on the number of steps or the walking speed of the user. The search result transmitting unit is configured to transmit a search result after the correction to the terminal apparatus. This intends to make the route search process efficient by using the transfer cost designed in advance using the assumed walking speed for each classification when the walking condition of the user is classified into a plurality of stages, and allows an individually and specifically appropriate result to be outputted by executing the search result correcting process when the divergence between the actual walking speed of the user and the assumed walking speed is significant large.

<Third Modification>

Although the example in which the search result correcting unit 207B is mounted to the terminal apparatus 20 has been explained in the abovementioned third embodiment, the search result correcting unit 207B may be mounted to the route search server 30. In this case, the terminal apparatus 20 may simply store, as similar to the abovementioned first modification or by other methods, a value indicating the measurement time number of steps and/or value indicating the walking speed of the user in a search request, and transmit the search request to the route search server 30. The route search server 30 may simply acquire the value indicating the measurement time number of steps and/or the value indicating the walking speed of the user, in response to the search request from the terminal apparatus 20, and correct the search result, with the procedure similar to the search result correcting processes S701A to S710B illustrated in FIG. 13, at the route searching process S302.

In the route search server 30 according to a third modification, in addition to the configuration indicated in the abovementioned second modification, the search result correcting unit is configured to set, when correcting the desired time of the walking section in the route candidate included in the search result, a re-search target route that is a route subsequent to the corrected walking section and a departure start time that is the time in which the walking time after the correction is added to the arrival expectation time of a route prior to the walking section, to a second search condition, to cause the route searching unit to execute a route search using the second search condition, acquire a second search result including a route candidate that satisfies the second search condition from the route searching unit, and correct the re-search target route included in the search result using the route candidate included in the second search result. This intends to make the route search process efficient by using the transfer cost designed in advance using the assumed walking speed for each classification when the walking condition of the user is classified into a plurality of stages, and allows an individually and specifically appropriate result to be outputted by executing the search result correcting process when the divergence between the actual walking speed of the user and the assumed walking speed is significant large.

<Hardware Configuration>

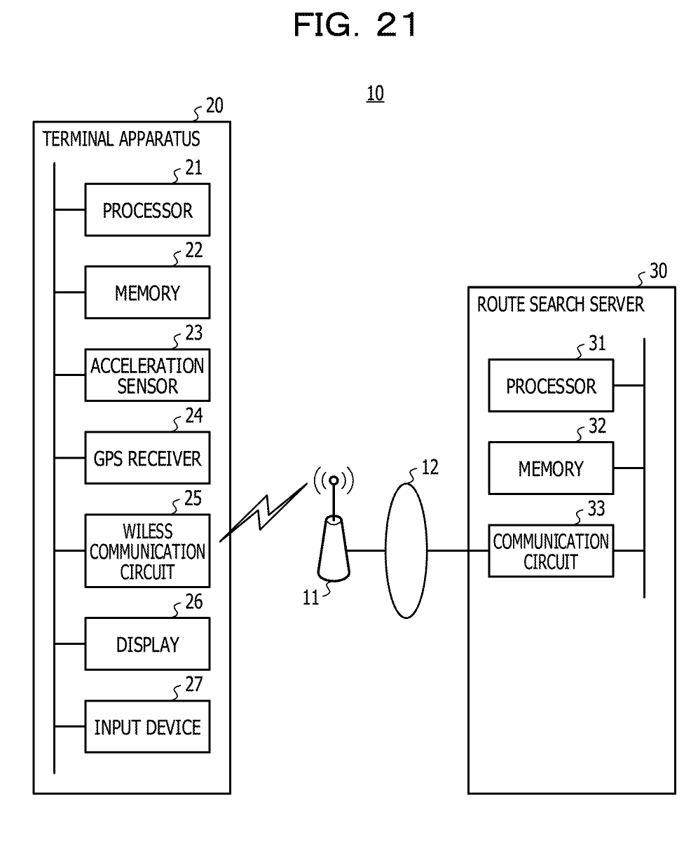

Lastly, the hardware configuration of the respective apparatuses used in the embodiments are briefly described. FIG. 21 is a diagram illustrating one example of the hardware configuration of the terminal apparatus 20 and the route search server 30 in the route search system 10. The terminal apparatus 20 illustrated in FIG. 21 includes a processor 21, a memory 22, an acceleration sensor 23, a GPS receiver 24, a wireless communication circuit 25, a display 26, and an input device 27. The processor 21 is a computation device that implements an operation as the terminal apparatus 20 that uses route search service by executing a program stored in the memory 22. Examples of such a processor 21 may include a central processing unit (CPU), a micro processing unit (MPU), a digital signal processor (DSP), and a field programmable gate array (FPGA). The processor 21 is one example of a hardware circuit that implements the various kinds of process units according to the first to third embodiments by executing programs stored in the memory 22. Noted that the processor 21 may be a multi-core processor that includes two or more cores.

The memory 22 illustrated in FIG. 21 is a device that stores and holds the program executed by the processor 21, and data that is referred to and written in when the processor 21 performs processing, and is configured to include both of or either one of a nonvolatile storage device and a volatile storage device. Examples of the memory 22 include a random access memory (RAM), a read only memory (ROM), a solid state drive (SSD), and a hard disk drive (HDD). In the present embodiment, various kinds of storage devices such as a main storage device and an auxiliary storage device are collectively referred to as the memory 22. The memory 22 of the terminal apparatus 20 according to the first embodiment stores therein programs to cause the processor 21 to operate as the movement measuring unit 201, the status determining unit 202, the search condition setting unit 203, the search request transmitting unit 204, the search result receiving unit 205, and the search result displaying unit 206. The memory 22 of the terminal apparatus 20 according to the second embodiment stores therein, in addition to the programs according to the abovementioned first embodiment, a program to cause the processor 21 to operate as the search result correcting unit 207A. The memory 22 of the terminal apparatus 20 according to the third embodiment stores therein, in addition to the programs according to the abovementioned first embodiment, a program to cause the processor 21 to operate as the search result correcting unit 207B.

The acceleration sensor 23 is a sensor configured to detect acceleration components in X, Y, and Z axes direction in the three-dimensional space coordinates system, and is capable of detecting the number of steps that the user has walked based on the cycle of the acceleration component in each axis direction. Moreover, the acceleration sensor 23 may also be used to detect whether the user is in a walking state or a stopped state by measuring the number of steps based on detection signals from the acceleration sensor 23. In addition, the acceleration sensor 23 is configured to notify the processor 21 of the detected number of steps of the user via the memory 22 or directly. The GPS receiver 24 is configured to measure a current position of the terminal apparatus 20 by receiving GPS signals. In addition, the GPS receiver 24 is configured to notify the processor 21 of position information indicating a current position of the terminal apparatus 20, via the memory 22 or directly. The wireless communication circuit 25 is a communication circuit that implements communication with the route search server 30 via the network 12, by wireless communication with an access point 11 (also referred to as wireless base station) in conformity with the predetermined wireless communication standard, and may be, for example, a wireless communication apparatus in conformity with the wireless communication standard (for example, long term evolution (LTE)) defined by the 3rd generation partnership project (3GPP). The wireless communication circuit 25 has a function to make communication with the route search server 30 via the network 12 available, and is configured to transmit a search request, and receive a search result. The display 26 is configured to display a process result by the processor 21, such as a search condition input screen or a search result display screen, and is a display device, for example, a liquid crystal display (LCD), an organic electro luminescence (OEL) display, or an organic light-emitting diode (OLED) display. The input device 27 is configured to output an input signal in accordance with an input operation by the user to the processor 21, and may be a touch panel in combination with the display 26.

The route search server 30 illustrated in FIG. 21 includes a processor 31, a memory 32, and a communication circuit 34. The processor 31 is a computation device that implements an operation as the route search server 30 that provides route search service by executing a program stored in the memory 32. Examples of such a processor 31 may include a central processing unit (CPU), a micro processing unit (MPU), a digital signal processor (DSP), and a field programmable gate array (FPGA). The processor 31 is one example of a hardware circuit that implements the various kinds of process units according to the first to third embodiments by executing programs stored in the memory 32. Noted that the processor 31 may be a multi-core processor that includes two or more cores.

The memory 32 illustrated in FIG. 21 is a device that stores and holds the program executed by the processor 31, and data that is referred to and written in when the processor 31 performs processing, and is configured to include both of or either one of a nonvolatile storage device and a volatile storage device. Examples of the memory 22 include a random access memory (RAM), a read only memory (ROM), a solid state drive (SSD), and a hard disk drive (HDD). In the present embodiment, various kinds of storage devices such as a main storage device and an auxiliary storage device are collectively referred to as the memory 32. The memory 32 of the route search server 30 stores therein programs to cause the processor 31 to operate as the search request receiving unit 301, the route searching unit 302, and the search result transmitting unit 303. Moreover, the memory 32 may store therein various kinds of databases such as the route search network database 304 and the station timetable database 305. The communication circuit 34 is used as a wired or wireless interface to connect to the network 12, and includes, for example, an electric circuit for communication using a physical layer in an open systems interconnection (OSI) reference model being mounted thereon. The communication circuit 34 has a function to make communication with the terminal apparatus 20 via the network 12 available, and is configured to receive a search request from the terminal apparatus 20, and transmit a search result.

According to the above detailed descriptions, the features and the advantages of the embodiment are apparent. This intends to make the scope of the claims cover such features and advantages of the embodiment without departing from the spirit and scope of the disclosure. Moreover, those skilled in the art may easily conceive of all modifications and variations. Therefore, the disclosure is not limited to the above scope of the embodiment having the inventiveness, but may be based on appropriate modifications and equivalents that fall within the scope of the disclosed embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for a route search, the apparatus comprising:
a memory; and
a processor coupled to the memory and configured to
execute a process A-1 that includes measuring information related to movement of a user,
execute a process A-2 that includes determining a walking condition indicating a walking status of the user, based on the information related to the movement of the user measured by the process A-1,
execute a process A-3 that includes setting the information related to the walking condition of the user obtained by the process A-2 to a search condition including a departure location and a destination,
execute a process A-4 that includes transmitting a search request including the search condition, to a route search server that searches a route candidate including the departure location and the destination indicated by the search condition, and searches, when the route candidate includes a transfer section, the route candidate including the transfer section that satisfies the walking condition,
execute a process A-5 that includes receiving a search result including the route candidate that satisfies the search condition, from the route search server, and
execute a process A-6 that includes displaying the route candidate included in the search result.

2. The apparatus according to claim 1,
wherein the process A-1 includes measuring, as the information related to the movement of the user, the number of steps that the user has walked, and
wherein the process A-2 includes determining the walking condition of the user, by acquiring a walking speed of the user based on the number of steps measured within a predetermined period of time, and comparing the walking speed with one or more thresholds.

3. The apparatus according to claim 2,
wherein the processor is further configured to execute a process A-7 that includes correcting, when a difference between the walking speed of the user obtained by the determining and the one or more thresholds is a predetermined value or more, a desired time of a walking section in the route candidate included in the search result having received from the route search server based on the acquired walking speed, and
wherein the process A-6 includes displaying a route candidate included in the search result after the correction.

4. The apparatus according to claim 3,
wherein the process A-7 includes
setting, when the desired time of the walking section in the route candidate included in the search result is corrected, a re-search target route that is a route subsequent to the corrected walking section and a departure start time that is a time in which the walking time after the correction is added to an expectation time in a route prior to the walking section are set to a second search condition, and transmitting a search request including the second search condition to the route search server,
receiving a second search result including a route candidate that satisfies the second search condition from the route search server, and
correcting the re-search target route included in the search result using the route candidate included in the second search result.

5. A server apparatus for a route search, the apparatus comprising:
a memory; and
a processor coupled to the memory and configured to
execute a process B-1 that includes receiving, from a terminal apparatus that measures information related to movement of a user, a search request including a search condition to which the information related to the movement of the user, a departure location, and a destination are set,
execute a process B-2 that includes determining a walking condition indicating a walking status of the user based on the information related to the movement of the user set to the search condition in the search request having received from the terminal apparatus,
execute a process B-3 that includes searching a route candidate that satisfies the departure location and the destination set in the search condition, when the route candidate includes a transfer section, the route candidate including the transfer section that satisfies the walking condition of the user obtained by the process B-2, and
execute a process B-4 that includes transmitting a search result including the route candidate searched by the process B-3, to the terminal apparatus.

6. The apparatus according to claim 5,
wherein the process B-1 includes receiving, as the information related to the movement of the user, the search request in which the walking speed of the user is set, from the terminal apparatus, and
wherein the process B-2 includes determining the walking condition of the user, by comparing the walking speed of the user acquired from the search request having received from the terminal apparatus with one or more thresholds.

7. The apparatus according to claim 6,
wherein the processor is further configured to execute a process B-5 that includes correcting, when a difference between the walking speed of the user acquired from the search request having received from the terminal apparatus and the one or more thresholds is a predetermined value or more, a desired time of a walking section in the route candidate searched by the process B-3 based on the acquired walking speed, and
wherein the process B-4 includes transmitting the search result after the correction to the terminal apparatus.

8. The apparatus according to claim 7,
wherein the process B-5 includes
setting, when the desired time of the walking section in the route candidate included in the search result is corrected, a re-search target route that is a route subsequent to the corrected walking section and a departure start time that is a time in which the walking time after the correction is added to the expectation time in a route prior to the walking section are set to a second search condition,
acquiring, by executing the route search based on the second search condition using the process B-4, a second search result including a route candidate that satisfies the second search condition, and
correcting the re-search target route included in the search result using the route candidate included in the second search result.

9. A non-transitory computer-readable storage medium for storing a program that causes a processor to execute a process for route search, the process comprising:
executing a process A-1 that includes measuring information related to movement of a user,
executing a process A-2 that includes determining a walking condition indicating a walking status of the user, based on the information related to the movement of the user measured by the process A-1,
executing a process A-3 that includes setting the information related to the walking condition of the user obtained by the determining to a search condition including a departure location and a destination,
executing a process A-4 that includes transmitting a search request including the search condition, to a route search server that searches a route candidate including the departure location and the destination indicated by the search condition, and searches, when the route candidate includes a transfer section, the route candidate including the transfer section that satisfies the walking condition,
executing a process A-5 that includes receiving a search result including the route candidate that satisfies the search condition, from the route search server, and
executing a process A-6 that includes displaying the route candidate included in the search result.

10. The non-transitory computer-readable storage medium according to claim 9,
wherein the process A-1 includes measuring, as the information related to the movement of the user, the number of steps that the user has walked, and
wherein the process A-2 includes determining the walking condition of the user, by acquiring a walking speed of the user based on the number of steps measured within a predetermined period of time, and comparing the walking speed with one or more thresholds.

11. The non-transitory computer-readable storage medium according to claim 10,
wherein the processor is further configured to execute a process A-7 that includes correcting, when a difference between the walking speed of the user obtained by the determining and the one or more thresholds is a predetermined value or more, a desired time of a walking section in the route candidate included in the search result having received from the route search server based on the acquired walking speed, and
wherein the process A-6 includes displaying a route candidate included in the search result after the correction.

12. The non-transitory computer-readable storage medium according to claim 11,
wherein the process A-7 includes
setting, when the desired time of the walking section in the route candidate included in the search result is corrected, a re-search target route that is a route subsequent to the corrected walking section and a departure start time that is a time in which the walking time after the correction is added to an expectation time in a route prior to the walking section are set to a second search condition, and transmitting a search request including the second search condition to the route search server,
receiving a second search result including a route candidate that satisfies the second search condition from the route search server, and
correcting the re-search target route included in the search result using the route candidate included in the second search result.
